(19) United States
(12) Patent Application Publication
(10) Pub. No.: US 2003/0234755 A1
(43) Pub. Date: Dec. 25, 2003

(54) Light-emitting device and method of driving the same

(76) Inventor: Jun Koyama, Sagamihara (JP)

Correspondence Address: FISH & RICHARDSON P.C., 1425 K STREET, N.W., 11TH FLOOR, WASHINGTON, DC, 20005-3500, US

(21) Appl. No.: 10/454,829

(22) Filed: Jun. 5, 2003

(30) Foreign Application Priority Data
Jun. 6, 2002 (JP) 2002-165372

(51) Int. Cl. G09G 3/32

(52) U.S. Cl. 345/82

(57) ABSTRACT

A light-emitting device which consumes a decreased amount of electric power without continuously and repetitively processing the same digital signals by the external circuit and by the drive circuit, and a method of driving the same. A plurality of storage circuits are arranged in each pixel in the light-emitting device. The plurality of pixels are divided into blocks. A D/A converter circuit is provided for each of the blocks. The digital signals stored in the storage circuits in each pixel are successively converted into analog signals through the D/A converter, and are input to a capacitor and to a gate electrode of a current-controlling TFT in the corresponding pixel. This constitution makes it possible to lower the consumption of electric power and to increase the numerical aperture.

### BACKGROUND OF THE INVENTION

1. Field of the Invention

This invention relates to a light-emitting device having light-emitting elements constituted by anodes, cathodes and an organic compound layer, and a method of driving the same. More particularly, the invention relates to a light-emitting device of an active matrix type having thin-film transistors (hereinafter referred to as TFTs) fabricated on an insulator, i.e., a light-emitting device of the active matrix type receiving video signals which are digital signals and converting these signals into analog signals through a D/A (digital/analog) converter circuit, and a method of driving the same.

2. Description of the Related Art

In recent years, there has been widely used a display device having elements formed on an insulator and, particularly, on a glass substrate by using a thin semiconductor film. For instance, there has been widely used a display device of an active matrix type by using TFTs. The active matrix type display device has pixels arranged in a matrix, a TFT (hereinafter referred to as pixel TFT) being arranged in each of the pixels, and the brightness of each pixel being controlled by using a pixel TFT to display an image.

In recent years, there has been developed a technology for simultaneously forming, by using a polycrystalline semiconductor, the TFTs for constituting a drive circuit in addition to the pixel TFTs for constituting pixels in a peripheries of the pixel unit. This contributes greatly to reducing the size of the device and reducing the consumption of electric power. Accompanying this trend, the active matrix type display device is becoming an indispensable display unit for portable information devices which have now been very widely used in this field of application. As the active matrix type display devices, further, there have been proposed active matrix type liquid crystal display devices using liquid crystal elements, and active matrix type light-emitting devices using organic electric-field light-emitting elements (light-emitting elements). In this specification, attention is given particularly to the active matrix type light-emitting device.

Here, the light-emitting element is constituted by a first electrode electrically connected to a TFT formed on the substrate, an organic compound layer formed on the first electrode, and a second electrode formed on the organic compound layer. The organic compound layer is formed of an organic compound, and for which a known material of the high-molecular type or the low-molecular type can be freely used. In the present invention, further, an inorganic material can be used as a part of the organic compound layer.

FIG. 19 is a diagram schematically illustrating an active matrix type light-emitting device of a type (hereinafter referred to as digital type) that produces a display using digital signals.

A pixel unit 3008 is arranged at the center. A plurality of pixels are arranged in the pixel unit 3008 in a matrix. A plurality of source signal lines and a plurality of gate signal lines are arranged for inputting digital signals to the pixels.

A source signal line drive circuit 3001 is arranged on the upper side of the pixel unit 3008 for controlling signals that are input to the source signal lines. The source signal line drive circuit 3001 includes a shift register 3003, a first latching circuit 3004, a second latching circuit 3005, a D/A (digital/analog) converter circuit (denoted as DAC in the drawing) 3006, an analog switch 3007 and the like. Gate signal line drive circuits 3002 are arranged on the right and left sides of the pixel unit 3008 for controlling the signals to be input to the gate signal lines. In FIG. 19, the gate signal line drive circuits 3002 are arranged on both the right and left sides of the pixel unit 3008. The gate signal line drive circuit 3002, however, may be arranged on one side only. It is, however, desired that the gate signal line drive circuits are arranged on both sides of the pixel unit 3008 from the standpoint of efficiency of driving and reliability of driving.

Next, FIG. 20 illustrates the constitution of a general pixel unit in the active matrix type light-emitting device.

Each pixel includes a capacitor 3101, a switching TFT 3102, a current-controlling TFT 3103 and a light-emitting element 3104. The gate electrode of the switching TFT 3102 in each pixel is connected to any one of gate signal lines (G1 to Gy), either the source region or the drain region of the switching TFT 3102 in each pixel is connected to any one of the source signal lines (S1 to Sx) and the other one is connected to one electrode of the capacitor 3101 and to the gate electrode of the current-controlling TFT 3103. Further, the other electrode of the capacitor 3101 and either the source region or the drain region of the current-controlling TFT are connected to any one (Vt) of current feeder lines (V1 to Vx).

An analog signal input to the source signal lines (S1 to Sx) is input to the capacitor 3101 and to the gate electrode of the current-controlling TFT 3103 across the drain and source of the switching TFT 3102 that is rendered conductive by a signal input to the gate signal lines (G1 to Gy). The voltage of this signal controls the amount of electric current that flows into the current-controlling TFT 3101 from the current feeder line (V), and the brightness of the light-emitting element is controlled as the controlled amount of electric current flows into the light-emitting element.

Next, the operation of the active matrix type light-emitting device will be described with reference to a timing chart of FIG. 21.

First, a signal is input from the source signal line in a first frame period (F1), and, then, signals are input in a second frame period (F2) and in a third frame period (F3).

The gate signal line (G1) is selected in the first frame period (F1). Then, the switching TFT 3102 (FIG. 20) having a gate electrode connected to the gate signal line (G1) is rendered conductive. Then, signals are input from the source signal lines (S1 to Sx).

In FIG. 21, attention is given to a given source signal line (Sm)(m is a natural number which is not larger than x), and only those signals input to the source signal line (Sm) are illustrated. Here, a period in which a gate signal line is selected is called one horizontal period (1 line period: L). In particular, a period in which the gate signal line (G1) is selected is called a first line period (L1).

A signal is input to the switching TFT 3102 connected to the gate signal line (G1), a predetermined voltage is applied to the gate electrode of the current-controlling TFT connected to the switching TFT 3102 and, then, a signal is input to the next gate signal line (G2), whereby the switching TFTs 3102 connected to the gate signal line (G2) are all rendered conductive. Thus, the input of signal starts in the second line period (L2).

The above operation is repeated for all gate signal lines (G1 to Gy), and one frame period ends when the operation is effected up to the y-th line period (Ly).

Next, the second frame period (F2) starts. In the second frame period (F2), similarly, a signal is input to the source signal line.

When the second frame period (F2) ends, the third frame period (F3) starts. An image is displayed by repeating the above operation.

In a general active matrix light-emitting device, however, the display of screen is updated about 60 times a second to smoothly display the dynamic image. That is, the digital signal must be fed for every frame period by the operation method described above, and the signal must be written to all pixels every time. Even when the image to be displayed is a static image, the same signals must be continued to be supplied for every frame period. Accordingly, the external circuit and the drive circuit must repetitively process the same digital signals continuously.

There has further been proposed a method according to which digital signals of a static image are once written into an external storage circuit and, thereafter, the digital signals are supplied to the light-emitting device from the external storage circuit for every frame period. In either case, the external storage circuit and the drive circuit must be continuously operated.

In the portable information devices, further, the external circuit and the drive circuit must be continuously operated even at the time of displaying a static image, though a majority proportion of the periods are for displaying a static picture. Therefore, though it has been urged to decrease the consumption of electric power, difficulties are involved for achieving the above desire.

### SUMMARY OF THE INVENTION

It is, therefore, an object of this invention to lower the consumption of electric power by the light-emitting device by providing a light-emitting device which can be driven without the need of continuously and repetitively processing the same digital signals by the external circuit and by the drive circuit, and by providing a driving method thereof.

Another object of the invention is to increase the numerical aperture of a structure (hereinafter referred to as a lower surface emission type) in which light generated by an organic compound layer is emitted from the side of the first electrodes of the light-emitting elements by decreasing the number of elements such as TFTs formed in the pixels as much as possible.

In the light-emitting device of this invention, each pixel has a plurality of storage circuits. Further, a D/A converter circuit is provided for every plurality of pixels.

In the thus constituted pixel, digital signals are stored by the plurality of storage circuits. The stored digital signals are converted into corresponding analog signals through the D/A converter circuit. The analog signals vary the brightness of the pixels. Concretely speaking, the voltages of the analog signals are applied to the gate electrodes of current-controlling TFTs in the pixels to control the amounts of electric currents flowing into the current-controlling TFTs. The thus controlled currents flow into the light-emitting elements to express the gray scale of the light-emitting elements.

When a static image is to be displayed by the light-emitting devices of the invention, if once written, then, the same data is continued to be written in the pixels. Accordingly, even if the signal is not input for every frame period, the signal stored in the storage circuit may be read out again to continuously display the static image. That is, when the static image is to be displayed, the signal of an amount of one frame period may be once processed, and the external circuit and the source signal line drive circuit need not be operated. This makes it possible to greatly reduce the consumption of electric power.

In the light-emitting device of the invention, further, a D/A converter circuit is provided for every plurality of pixels; i.e., the D/A converter circuit is shared by the plurality of pixels. The digital signals stored in the storage circuits in the pixels selected out of the plurality of pixels are successively input to the D/A converter circuit.

The constitution of the light-emitting device of the invention will now be described in detail. Each pixel includes a plurality of storage circuits, and digital signals can be stored in the pixels.

When the image to be stored is a static image, it may be written once. The data written into the pixel thereafter remains the same. Without the need of inputting the signal for each of the frame periods, therefore, the signal stored in the storage circuit may be read out again to continuously display the static image. That is, when the static image is to be displayed, the signals of an amount of one frame period may be processed, and the external circuit and the source signal line drive circuit need not be operated. This makes it possible to greatly reduce the consumption of electric power.

In a concrete constitution of the light-emitting device of the invention, a pixel unit includes a plurality of pixels, and each pixel includes a switching TFT, a current-controlling TFT, a light-emitting element (EL), a holding capacitor (Cs) and storage circuits. The storage circuits are arranged in a number corresponding to the number of bits. In the case of, for example, three bits, there are arranged three storage circuits in each pixel. Among the plurality of pixels, one pixel has a D/A converter circuit (DAC: 111) shared by the plurality of pixels. Further, each pixel has a source signal line (S), a gate signal line (G) and a current feeder line (V). When a plurality of pixels are arranged in x columns, there are formed source signal lines (S) of the number of x (S1 to Sx) as well as current feeder lines (V) of the number of x (V1 to Vx).

When a plurality of pixels are arranged in y rows, the gate signal lines (G) must be formed in a number corresponding to the number of bits for each pixel. In the case of, for example, 3 bits, there are formed the gate signal lines of the number of (y×3)(G1(1 to y), G2(1 to y), G3(1 to y)).

There are further formed switching TFTs connected to the gate signal lines (G) for writing, and storage circuits (M) connected to the switching TFTs. When digital video signals of n (n is a natural number of not smaller than 2) bits are to be stored by an amount of m (m is a natural number) frames, the storage circuits (M) must be formed in the number of n×m in each pixel.

When a static image is to be displayed in the invention, digital signals are stored in the storage circuits in each pixel in the first operation, and the digital signals stored in the storage circuits are repetitively read out by the DAC controller connected to the DAC among the frame periods. While the static image is being displayed, therefore, the source signal line drive circuit needs not be operated, and the consumption of electric power can be decreased.

In the light-emitting device of the invention, further, the D/A converter circuit formed in a pixel is shared by a plurality of pixels. Therefore, a decreased area is occupied by the D/A converter circuit as compared with when the D/A converter circuit is formed in each pixel, and a high numerical aperture is realized.

The constitution of the invention is concerned with a light-emitting device for expressing a gray scale by using digital signals of n bits (n is a natural number of not smaller than 2), wherein:

a pixel unit in the light-emitting device is divided into blocks each containing pixels of the number of k (k is a natural number of not smaller than 2);

a D/A converter circuit is provided for each block;

each of the pixels of the number of k includes storage circuits of the number of n, a TFT and a light-emitting element;

the D/A converter circuit is connected to the storage circuits of the number of n and to the TFTs possessed by the pixels of the number of k through switching means;

and wherein provision is made of:

means for storing digital signals of n bits in the storage circuits of the number of n;

means for selecting a pixel out of the pixels of the number of k, and for in putting digital signals of n bits stored in the storage circuits of the one pixel to the D/A converter circuit; and

means for inputting an analog signal output from the D/A converter circuit to a gate electrode of the TFT in one pixel;

the TFT and the light-emitting element being connected together.

Another constitution of the invention is concerned with a light-emitting device for expressing a gray scale by using digital signals of n bits (n is the natural number of not smaller than 2), wherein:

the device is divided into blocks each containing pixels of the number of k (k is a natural number of not smaller than 2);

a gate signal line drive circuit and a source signal line drive circuit are formed therein;

a D/A converter circuit is provided for each of the blocks;

each of the pixels of the number of k includes storage circuits of the number of n, first TFTs of the number of n, a second TFT and a light-emitting element;

the D/A converter circuit is connected to the storage circuits of the number of n and to the second TFTs possessed by the pixels of the number of k through switching means;

the first TFTs of the number of n are connected to the storage circuits of the number of n, respectively;

the first TFTs of the number of n are rendered conductive by an output signal from the gate signal line drive circuit;

and wherein provision is made of:

means for inputting an output signal from the source signal line drive circuit to the storage circuits of the number of n through the first TFTs of the number of n;

means for selecting a pixel out of the pixels of the number of k, and for inputting the digital signals of n bits stored in the storage circuits of the number of n in the one pixel to the D/A converter circuit; and

means for inputting an analog signal output from the D/A converter circuit to a gate electrode of the second TFT in one pixel;

the second TFT and the light-emitting element being connected together.

In the above constitution, either the source signal line drive circuit or the gate signal line drive circuit has an address decoder, or both of them have an address decoder.

In the above constitution, further, the pixels of the number of k, the source signal line drive circuit and the gate signal line drive circuit are formed on the same substrate.

A further constitution of the invention is concerned with a method of driving a light-emitting device with digital signals of n bits, the light-emitting device being divided into blocks each containing pixels of the number of k (k is a natural number of not smaller than 2), each pixel having storage circuits of the number of n, a TFT and a light-emitting element, and the light-emitting device further having a D/A converter circuit for each of the blocks, wherein:

digital signals of n bits are stored in the memory circuits of the number of n possessed by the pixels of the number of k;

one pixel is selected out of the pixels of the number of k, and the digital signals of n bits are input to the D/A converter circuit connected to the storage circuits of the number of n in one pixel through switching means; and

an analog signal output from the D/A converter circuit is input to a gate electrode of the TFT in the pixel connected to the D/A converter circuit through the switching means;

so that a predetermined current flows into the light-emitting element through the TFT in the pixel.

In the method of driving the light-emitting device constituted as described above, the digital signals of n bits are once stored in the storage circuits of the number of n, and, then, the digital signals of n bits are input to the D/A converter circuit from the storage circuits of the number of n in the pixel, and the analog signals output from the D/A converter circuit are input to the gate terminals of the TFT in the pixels, which are repeated for a predetermined period of time.

A further constitution of the invention is concerned with a method of driving a light-emitting device with digital signals of n bits, the light-emitting device being divided into blocks each containing pixels of the number of k (k is a natural number of not smaller than 2), each pixel having storage circuits of the number of n, first TFTs of the number of n, a second TFT and a light-emitting element, and the light-emitting device further having a D/A converter circuit for each of the blocks, a gate signal line drive circuit and a source signal line drive circuit, wherein:

the first TFTs of the number of n possessed by the pixels of the number of k are rendered conductive by an output signal from the gate signal line drive circuit;

digital signals of n bits from the source signal line drive circuit are stored in the memory circuits of the number of n through the first TFTs of the number of n;

one pixel is selected out of the pixels of the number of k, and the digital signals of n bits are input to the D/A converter circuit connected to the storage circuits of the number of n in one pixel through switching means; and

an analog signal output from the D/A converter circuit is input to a gate electrode of the second TFT in the pixel connected to the D/A converter circuit through the switching means;

so that a predetermined current flows into the light-emitting element through the second TFT in the pixel.

In the method of driving the light-emitting device constituted as described above, the digital signals of n bits are once stored in the storage circuits of the number of n, and, then, the digital signals of n bits are input to the D/A converter circuit from the storage circuits of the number of n in the pixel, and the analog signals output from the D/A converter circuit are input to the gate terminals of the second TFTS, which are repeated for a predetermined period of time.

In the method of driving the light-emitting device constituted as described above, the digital signals of n bits are once stored in the storage circuits of the number of n, and, then, the digital signals of n bits are input to the D/A converter circuit from the storage circuits of the number of n in the pixel, and the analog signals output from the D/A converter circuit are input to the gate terminals of the second TFTs, which are repeated for a predetermined period of time, while halting the operation of the gate signal line drive circuit.

Further, in the method of driving the light-emitting device constituted as described above, the digital signals of n bits are once stored in the storage circuits of the number of n, and, then, the digital signals of n bits are input to the D/A converter circuit from the storage circuits of the number of n in the pixel, and the analog signals output from the D/A converter circuit are input to the gate terminals of the second TFTs, which are repeated for a predetermined period of time, which are repeated for a predetermined time, while halting the operations of the source signal line drive circuit and of the gate signal line drive circuit.

### BRIEF DESCRIPTION OF THE DRAWINGS

FIGS. 1A and 1B are diagrams illustrating the constitution of pixels in a light-emitting device of the invention;

FIG. 2 is a diagram illustrating the constitution of the light-emitting device;

FIG. 3 is a diagram illustrating the constitution of pixels in the light-emitting device of the invention;

FIG. 4 is a timing chart illustrating a method of driving the light-emitting device of the invention;

FIG. 5 is a diagram illustrating the constitution of a DAC used in the light-emitting device of the invention;

FIGS. 6A and 6B are diagrams illustrating the constitution of pixels in the light-emitting device of the invention;

FIG. 7 is a timing chart illustrating the method of driving the light-emitting device of the invention;

FIG. 8 is a diagram illustrating the constitution of the DAC used in the light-emitting device of the invention;

FIG. 9 is a diagram illustrating the constitution of the DAC used in the light-emitting device of the invention;

FIG. 10 is a diagram illustrating the constitution of the DAC used in the light-emitting device of the invention;

FIG. 11 is a diagram illustrating the constitution of a source signal line drive circuit of the invention;

FIG. 12 is a diagram illustrating the constitution of pixels in the light-emitting device of the invention;

FIG. 13 is a timing chart illustrating the method of driving the light-emitting device of the invention;

FIG. 14 is a diagram illustrating the constitution of the source signal line drive circuit of the invention;

FIG. 15 is a diagram illustrating the constitution of a gate signal line drive circuit of the invention;

FIGS. 16A and 16B are diagram illustrating the constitution of the light-emitting device of the invention;

FIGS. 17A and 17B are diagrams illustrating the constitution of a storage circuit used in the light-emitting device of the invention;

FIGS. 18A to 18H are diagrams illustrating electric appliances using the light-emitting device of the invention;

FIG. 19 is a diagram illustrating the constitution of a conventional light-emitting device;

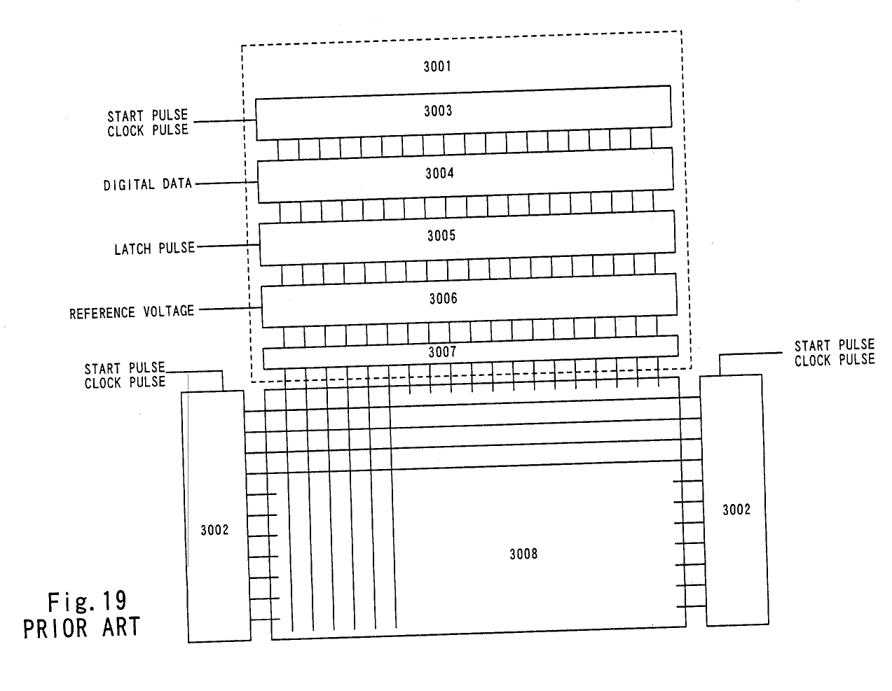

FIG. 20 is a diagram illustrating the constitution of a pixel unit in the conventional light-emitting device; and

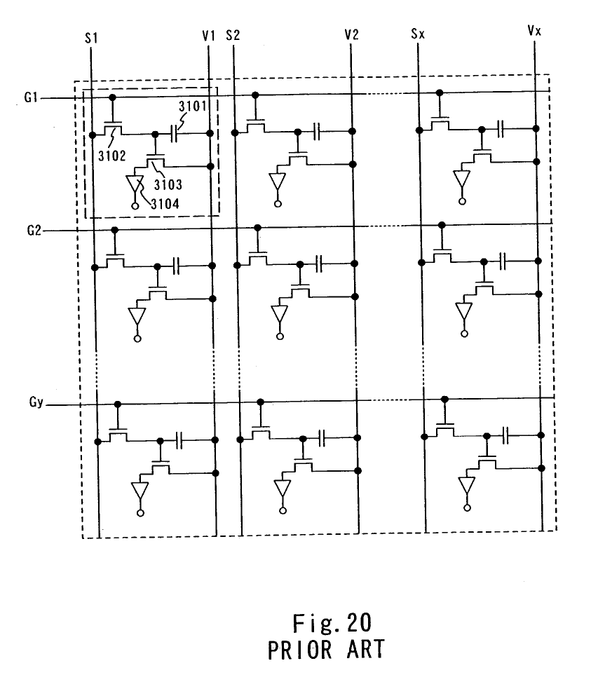

FIG. 21 is a timing chart illustrating a conventional driving method.

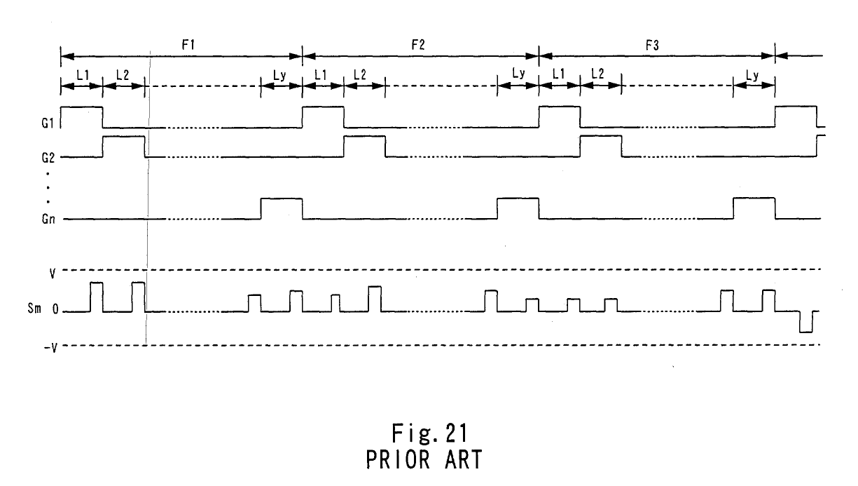

### DETAILED DESCRIPTION OF THE INVENTION

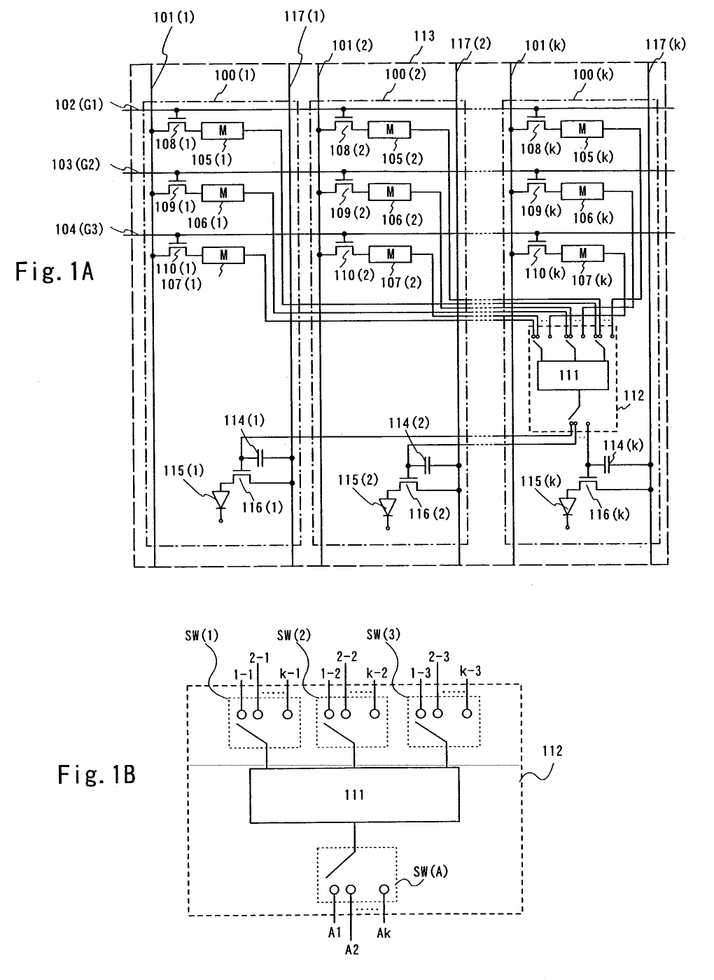

The constitution of pixels formed in a pixel unit in a light-emitting device of the invention will now be described with reference to FIGS. 1A and 1B.

The pixel unit is divided into several blocks each including a plurality of pixels, and a D/A converter circuit (abbreviated as DAC in the drawing) is shared in each block. FIGS. 1A illustrates a block 113 constituted by pixels of the number of k, where a digital signal is input to the pixels from a source signal line drive circuit via source signal lines (S)101, is stored in storage circuits (M)(105 to 107), is converted into an analog signal through a DAC 111 shared by the pixels of the number of k, and is output to the pixels. Here, k is a natural number of not smaller than 2.

This embodiment deals with a case where the pixels included in the same block are all arranged on the same horizontal line in the pixel unit. That is, the switching TFTs for controlling the storage circuits (M) corresponding to the same bit in the pixels included in the same block, are all connected to the same gate signal line (G). The pixels of the number of k in one block are denoted by 100(1 to k).

The storage circuits (M) shown in FIG. 1A are each for storing a signal of one bit. Illustrated here is the case of 3 bits, and there are used three storage circuits (105 to 107). Switching TFTs 108(1 to k) work to control signals input to the storage circuits 105(1 to k) corresponding to the most significant bit D3 of the digital signals, switching TFTs 109(1 to k) work to control signals input to the storage circuits 106(1 to k) corresponding to D2, and switching TFTs 110(1 to k) work to control signals input to the storage circuits 107(1 to k) corresponding to the least significant bit D1 of the digital signals.

A gate signal line 102(G1) is connected to the gate electrodes of the switching TFTs 108(1 to k) possessed by all pixels 100(1) to 100(k) in the block 113, a gate signal line 103(G2) is connected to the gate electrodes of the switching TFTs 109(1 to k), and a gate signal line 104(G3) is connected to the gate electrodes of the switching TFTs 110(1 to k).

The pixels (100(1) to 100(k)) of the number of k included in the block 113 share the DAC 111. The pixels (100(1) to 100(k)) include source signal lines (S)101(1 to k), gate signal lines (G)((G1)102, (G2)103, (G)104), storage circuits (M)(105(1 to k), 106(1 to k), 107(1 to k)), switching TFTs (108(1 to k), 109(1 to k), 110(1 to k)), capacitors (Cs)114(1 to k), light-emitting elements 115(1 to k), and current control TFTs 116(1 to k).

The DAC 111 is connected to the capacitors 114(1 to k) and to the gate electrodes of the current-controlling TFTs 116(1 to k) possessed by the pixels, and analog signals converted through the DAC 111 are input thereto. Either the source regions or the drain regions of the current-controlling TFTs 116(1 to k) are connected to the current feeder lines 117(1 to k), and the other regions, i.e., the source regions or the drain regions of the current controlling TFTs 116(1 to k) are connected to the light-emitting elements 115(1 to k).

This embodiment has dealt with the case where each pixel included the storage circuits of a total of three bits. Not being limited thereto only, however, the invention can be further applied to a light-emitting device constituted by pixels having storage circuits for storing signals of any number of bits.

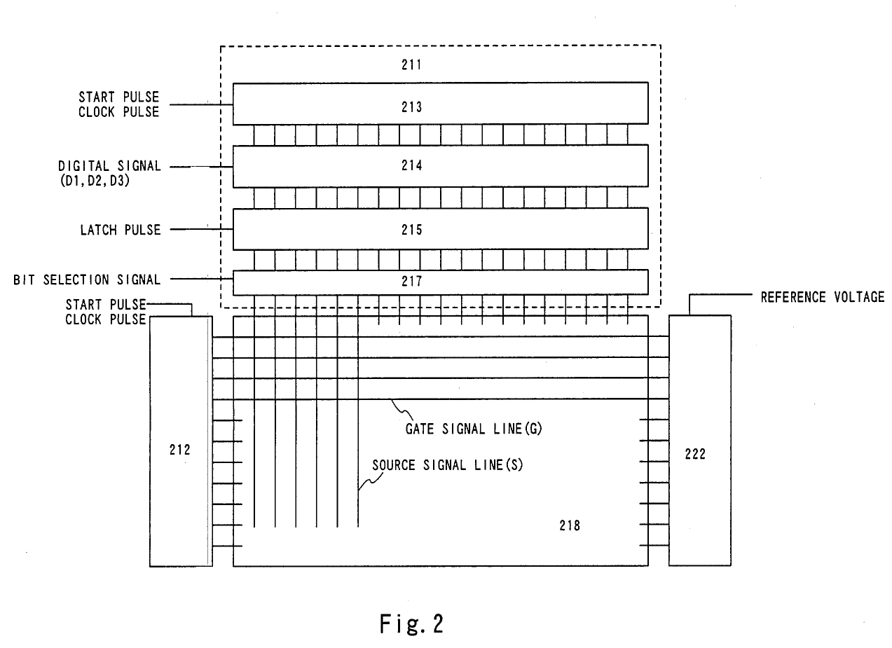

Described below with reference to a block diagram of FIG. 2 is a method of outputting, to the source signal line, the digital signals (D1, D2, D3) that are input to the source signal line drive circuit in the light-emitting device of the invention.

In FIG. 2, the light-emitting device is constituted by a pixel unit 218, a source signal line drive circuit 211, a gate signal line drive circuit 212, and a DAC (D/A converter circuit) controller 222.

The source signal line drive circuit 211 receives a start pulse, a clock pulse, a digital signal and a latch pulse, and the gate signal line drive circuit 212 receives a start pulse and a clock pulse. The DAC controller 222 receives a reference voltage.

The source signal line drive circuit 211 is constituted by a shift register 213, a first latch circuit 214, a second latch circuit 215 and a switch 217.

When clock signals (clock pulses, inverted clock pulses) and start pulses are input to the shift register 213 in the source signal line drive circuit, the pulses are successively input from the shift register 213 to the first latch circuit 214, and digital signals input to the first latch circuit 214 are held thereby. A digital signal includes a most significant bit (MSB) and a least significant bit (LSB). When a gray scale is to be displayed by inputting, for example, a digital signal of 3 bits (hereinafter referred to as 3-bit digital gray scale), D3 represents the most significant bit of the digital signal and D1 represents the least significant bit of the digital signal.

When the holding of digital signals of an amount of one horizontal period is completed in the first latch circuit 214, the digital video signals held by the first latch circuit 214 are transferred at one time to the second latch circuit 215 during the fly-back period in response to the input of a latch signal (latch pulse).

Then, the shift register 213 operates again to hold the digital signals of an amount of a next horizontal period. At the same time, the digital signals held by the second latch circuit 215 are selected in the switch 217 by a bit selection signal for every bit, and are input to the source signal lines (S1 to Sx).

The input digital signal is input to the switching TFTs (108(1 to k), 109(1 to k), 110(1 to k)) that have been rendered conductive by signals input from the gate signal lines ((G1)102, (G)103, (G)104) shown in FIG. 1.

Next, the DAC 111 shared by the block 113 and the peripheries (region 112) thereof will be described with reference to FIG. 1B. Described below is the operation for converting the digital signals stored in the storage circuits (105(1 to k), 106(1 to k), 107(1 to k)) into analog signals.

In FIG. 1B, the digital signals of bits from the storage circuits (105(1 to k), 106(1 to k), 107(1 to k)) in each pixel are selected by the switches SW(1) to SW(3) corresponding to the signals. Here, the switch for selecting digital signals of the least significant bit from the storage circuits 107(1 to k) is denoted by SW(1), and the switch for selecting digital signals of the most significant bit from the storage circuits 105(1 to k) is denoted by SW(3).

After the digital signals of 3 bits are held by the storage circuits (105(1 to k), 106(1 to k), 107(1 to k)) in each pixel, signals 1-1, 1-2 and 1-3 from the storage circuits (105(1), 106(1), 107(1)) in the first pixel 100(1) are selected by the switches SW(1) to SW(3) and are input to the DAC 111. The 3-bit signal is converted into an analog signal through the DAC 111. At the same time, a terminal A1 is selected by a switch SW(A), and the analog signal output from the DAC 111 is fed, as an output corresponding to the pixel 100(1), to the capacitor (Cs)114(1) of the pixel 100(1) and to the gate electrode of the current-controlling TFT 116(1). Namely, there is produced an analog signal corresponding to the first pixel 100(1).

Next, signals 2-1, 2-2 and 2-3 from the storage circuits (105(2), 106(2), 107(2)) of the second pixel 100(2) are selected by the switches SW(1) to SW(3) and are input to the DAC 111. The 3-bit digital signal is converted into an analog signal through the DAC 111. At the same time, a terminal A2 is selected by a switch SW(A). The analog signal output from the DAC 111 is fed, as an output corresponding to the pixel 100(2), to the capacitor (Cs)114(2) of the pixel 100(2) and to the gate electrode of the current-controlling TFT 116(2). Namely, there is produced an analog signal corresponding to the second pixel 100(2).

The same operation is conducted for all of the pixels of the number of k sharing the DAC 111. Thus, the digital signals stored in the storage circuits (105(1 to k), 106(1 to k), 107(1 to k)) of all pixels are converted into analog signals through the DAC 111.

Further, the above operation is conducted for all of the blocks to convert the digital signals stored in all of the pixels in the pixel unit into analog signals. The above operation can be simultaneously effected for all of the blocks.

According to the invention as described above, one DAC is shared by a plurality of pixels and, hence, a decreased area is occupied by the DAC in the pixel unit, making it possible to increase the numerical aperture or to increase the storage circuits as compared to the prior art.

Embodiments

The invention will now be described by way of embodiments.

[Embodiment 1]

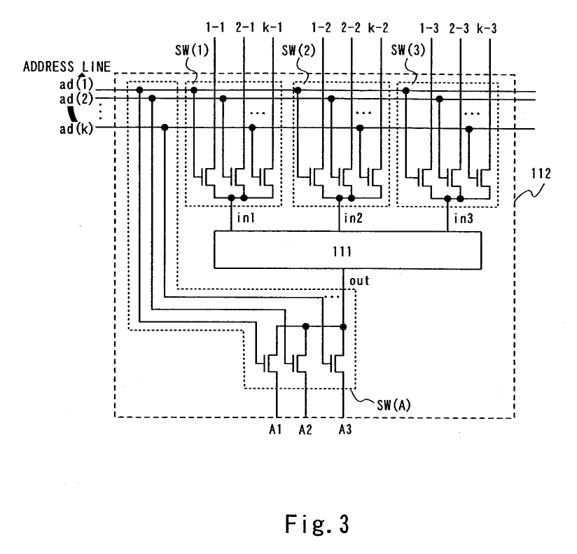

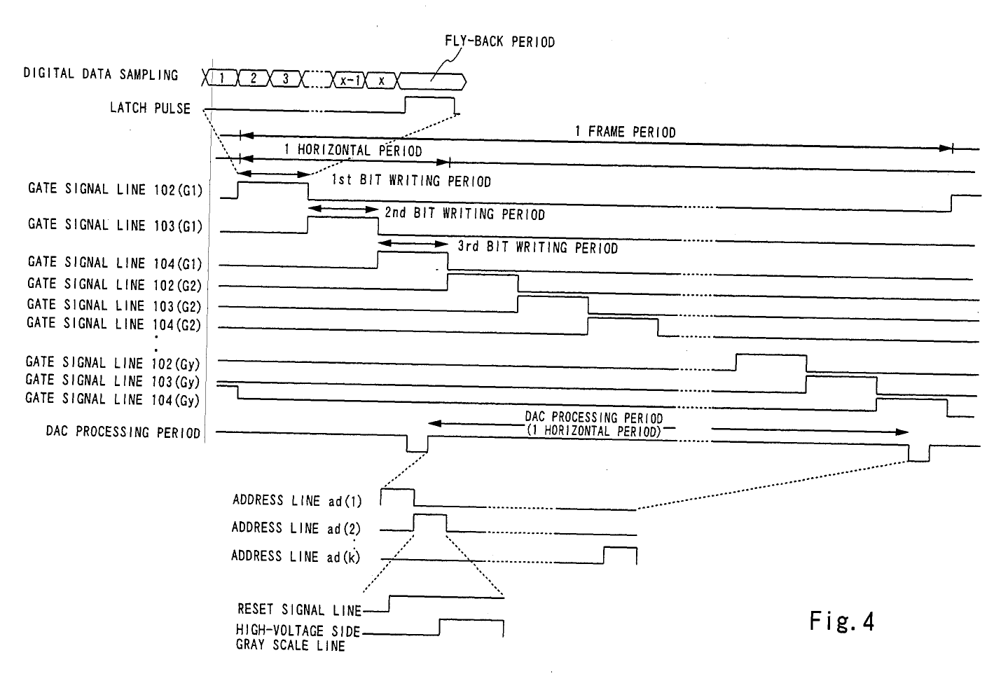

This embodiment illustrates the constitution shown in FIGS. 1A and 1B and the constitution of the periphery (region 112) of the DAC 111 with reference to FIG. 3 or 4. In FIG. 3, the portions same as those of FIGS. 1A and 1B are denoted by common reference numerals.

This embodiment illustrates pixels corresponding to the light-emitting device of the 3-bit digital gray scale. Not being limited thereto only, however, the embodiment can also be applied to a light-emitting device constituted by pixels having storage circuits of any number of bits.

The operation of the constitution shown in FIGS. 1A and 1B will now be described with reference to a timing chart of FIG. 4.

First, digital signals are held by the storage circuits (105(1 to k), 106(1 to k), 107(1 to k)) of the pixels illustrated with reference to FIG. 1A.

In the source signal line drive circuit, digital signals of an amount of a horizontal period are held (digital signal sampling period) according to a sampling pulse output from the shift register. Thereafter, digital signals transferred to the second latch circuit due to a latch pulse input during the fly-back period, are input to a source signal line.

One horizontal period can be divided into three periods, i.e., a first bit writing period, a second bit writing period and a third bit writing period.

During the first bit writing period, a digital signal (D3) is input to a source signal line due to a bit selection signal. At this moment, a signal is input to the gate signal line 102(G1), and the switching TFTs 108(1 to k) connected to the above gate signal line are rendered conductive. Thus, the digital signal (D3) of the first bit is written into the storage circuits (M)105(1 to k).

Next, in the second bit writing period, a digital signal (D2) is input to a source signal line due to a bit selection signal. At this moment, a signal is input to the gate signal line 103(G1), and the switching TFTs 109(1 to k) connected to the above gate signal line are rendered conductive. Thus, the digital signal (D2) of the second bit is written into the storage circuits (M)106(1 to k).

Next, in the third bit writing period, a digital signal (D1) is input to a source signal line due to a bit selection signal. At this moment, a signal is input to the gate signal line 104(G1), and the switching TFTs 110(1 to k) connected to the above gate signal line are rendered conductive. Thus, the digital signal (D1) of the third bit is written into the storage circuits (M)107(1 to k).

The digital signals thus written into the storage circuits (105(1 to k), 106(1 to k), 107(1 to k)) are converted (DAC processing period) into analog signals through the DAC 111 by utilizing a period of from the end of the digital signal sampling period in the third bit wiring period to the DAC processing period in the next horizontal period.

In this embodiment, the period for writing the digital signal may be shortened, i.e., the sampling of the shift register of the source signal line drive circuit may be quickened. Thus, the fly-back period of the shift register may be lengthened.

SW(1) to SW(3) and SW(A) shown in FIG. 3 are constituted by TFTs and address lines ad(1) to ad(k). The address lines ad(1) to ad(k) are used for sending signals from the storage circuits (105(1 to k), 106(1 to k), 107(1 to k)) to the DAC 111 and for sending the signals from the DAC 111 to the capacitors (Cs)114(1 to k) and to the gate electrodes of the current-controlling TFTs 116(1 to k) in the DAC processing period.

When a signal is input to the address line ad(1), the TFTs having gate electrodes connected to the address line ad(1) are rendered conductive. The address line that is selected stands for such a conductive state.

In this embodiment, further, the TFTs connected to the address line are all of the n-channel type. The TFTs, however, may be either the p-channel type or the n-channel type. Here, however, the TFTs connected to the same address line must have the same polarity.

When one address line (e.g., address line ad(1)) is selected, the other address lines (e.g., address lines ad(2) to ad(k)) are not selected.

When the address line ad(1) is selected, signals from the storage circuits (105(1), 106(1), 107(1)) are input to the DAC 111 through the TFTs that have been rendered conductive, are converted into analog signals through the DAC 111, and are input to the capacitor (Cs)114(1) and to the gate electrode of the current-controlling TFT 116(1) of the pixel 100(1). The amount of current flowing into the current-controlling TFT 116(1) is controlled depending upon the analog signal that is input, and the thus controlled current flows through the light-emitting element to control the brightness of the light-emitting element. In this embodiment which uses 3-bit signals, the brightness is obtained in eight steps of from 0 to 7.

Next, when the address line ad(2) is selected, other address lines ad(1), ad(3) to ad(k) are not selected. At this moment, signals are input to the DAC 111 from the storage circuits (105(2), 106(2), 107(2)) through the TFTs that have been rendered conductive, are converted into analog signals through the DAC 111, and are output to the capacitor (Cs)114(2) and to the gate electrode of the current-controlling TFT 116(2) of the pixel 100(2). The amount of current flowing into the current-controlling TFT 116(1) is controlled depending upon the analog signal that is input, and the thus controlled current flows through the light-emitting element to control the brightness of the light-emitting element. Similarly, here, the brightness is obtained in eight steps of from 0 to 7.

The same operation is repeated for all address lines, whereby all of the digital signals stored in the storage circuits (105(1 to k), 106(1 to k), 107(1 to k)) in the pixels (100(1) to 100(k)) of the block 113 are converted into analog signals, and the brightness of the light-emitting elements is controlled by the thus converted analog signals.

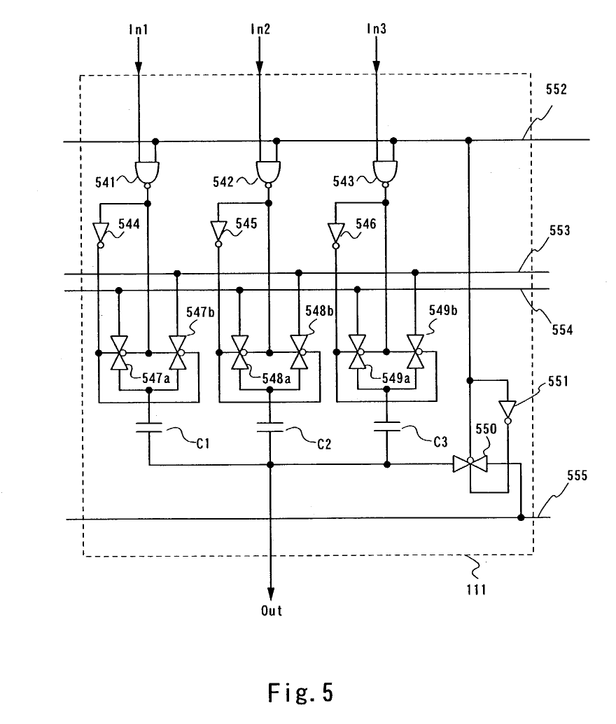

Next, a concrete constitution of the DAC 111 will be described with reference to FIG. 5. Terminals in1 to in3 and out in FIG. 5 are corresponding to the terminals in1 to in3 and out in FIG. 3.

The DAC 111 is constituted by NAND circuit 541 to 543, inverters 544 to 546 and 551, switches 547a to 549a, switches 547b to 549b, a switch 550, capacitors C1 to C3, a reset signal line 552, a low-voltage side gray scale power source line 553, a high-voltage side gray scale power source line 554 and an intermediate-voltage side gray scale power source line 555.

First, the switch 550 is rendered conductive due to a signal res input to the reset signal line 552, and the potential of the capacitors Cl to C3 on the side (hereinafter referred to as the opposing electrode side) connected to the terminal out, is fixed to the potential V_{M} of the intermediate-voltage side gray scale power source line 555. The potential of the high-voltage side gray scale power source line 554 is set to be equal to the potential V_{L} of the low-voltage side gray scale power source line 553. Here, no signal is written into the capacitors C1 to C3 even when digital signals are input to in1 to in3.

Thereafter, the signal res of the reset signal line 552 varies, the switch 550 turns off, and the fixed potential of the capacitors Cl to C3 on the side of the terminal out is reset. Next, the potential of the high-voltage side gray scale power source line 554 assumes a value V_{H} different from the potential V_{L} of the low-voltage side gray scale power source line 553. Here, the outputs of the NAND circuits 541 to 543 vary depending upon the signals input to the terminals in1 to in3, the switches 547 to 549 are rendered conductive on either side, and the potential V_{H} of the high-voltage side gray scale power source line or the potential V_{L} of the low-voltage side gray scale power source line is applied to the electrodes of the capacitors C1 to C3.

Here, the values of the capacitors C1 to C3 are set depending upon the bits.

The voltage of the opposing electrode side varies depending upon the voltage applied to the capacitors C1 to C3, and the output voltage varies. Namely, an analog signal corresponding to the digital signal input to in1 to in3, is produced from the terminal out.

In the DAC of the above constitution, the reference potential is divided by the capacitors C1 to C3 to express a variety of gray scales.

The DAC of the above capacity division type has been disclosed in a literature (AML CD99, Digest of Technical Papers, pp. 29-32).

In the foregoing was described the DAC for converting the 3-bit digital signals into analog signals. The embodiment, however, can also be applied even to a DAC that converts digital signals of different number of bits into analog signals.

Further, not only the DAC of the above structure but also the DAC of any known structure can be freely used for the light-emitting device of the invention. For example, there may be used a DAC of the resistance division type dividing the reference voltage by using resistors.

Reverting to FIG. 4, described below is the operation of the DAC processing periods by using the DAC of the constitution described above with reference to FIG. 5. The description further uses reference numerals of FIG. 5.

In the DAC processing periods, the following operations are carried out every time when the address lines ad(l) to ad(k) are selected.

A signal res is input to the reset signal line 552. Thereafter, the potential of the high-voltage side gray scale line 554 changes into V_{H}. Thus, the digital signal input to the DAC 111 is converted into an analog signal.

Here, the reset signal line 552 and the high-voltage side gray scale power source line 554 receive a signal from the DAC controller.

The above operation is conducted for all blocks to convert the digital signals stored in the storage circuits in all pixels into analog signals.

Here, in order to convert the digital signals of the pixels possessed by all blocks into analog signals as efficiently as possible, it is desired that the blocks are all constituted by the pixels of the same number.

The switches SW(1) to SW(3) and the switch SW(A) are not limited to those of the constitutions shown in FIG. 3, and the switches of various constitutions can be freely used.

While a static image is being displayed, if a digital signal is once written into the storage circuits possessed by the pixels, the digital signals stored in the pixels are converted into analog signals by the operation of the DAC described above, and the image is displayed. At this moment, the source signal line drive circuit, gate signal line drive circuit and other external circuits are not operated. Here, the DAC controller only may be operating for controlling the operation of the DACs in the blocks.

Thus, there is provided a light-emitting device having DACs occupying decreased areas in the pixel unit and consuming electric power in decreased amounts.

[Embodiment 2]

This embodiment deals with a constitution which is encompassed by the invention, and is different from the embodiment 1 with regard to the constitution of sharing the DAC.

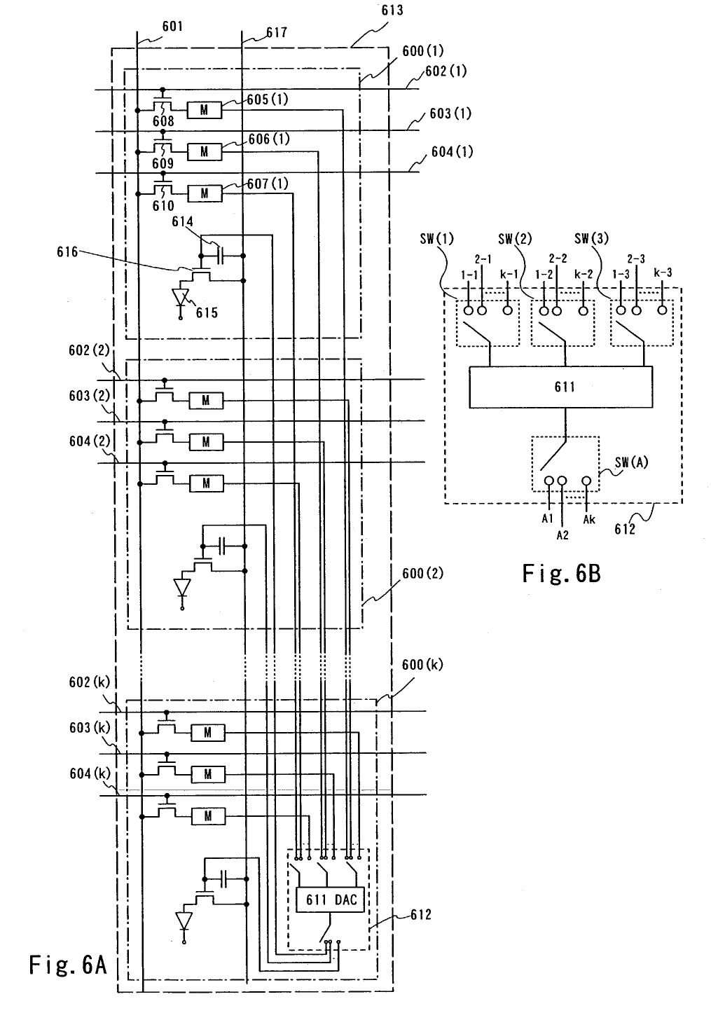

The constitution of the pixels of this embodiment will be described with reference to FIGS. 6A and 6B.

This embodiment, too, illustrates pixels corresponding to the light-emitting device of the 3-bit digital gray scale like the embodiment 1. Not being limited thereto only, however, the embodiment can also be applied to a light-emitting device constituted by pixels having storage circuits of any number of bits.

In FIG. 6A, a plurality of pixels 600(1) to 600(k) are sharing a DAC 611. Here, the DAC 611 may have the same structure as that of Example 1. Each pixel includes storage circuits (605(1 to k), 606(1 to k), 607(1 to k)), a source signal line 601, gate signal lines (602(1 to k), 603(1 to k), 604(1 to k)), switching TFTs (608(1 to k), 609(1 to k), 610(1 to k)), a current controlling TFT 616(1 to k), a light-emitting element 615(1 to k) and a capacitor 614(1 to k).

In this embodiment, the pixels included in the block 613 have the switching TFTs that are connected to the same source signal line 601. Namely, the pixels included in the block 613 are arranged in the vertical direction in the pixel unit in the light-emitting device of the invention. Namely, the pixels included in the block 613 are all connected in the same column.

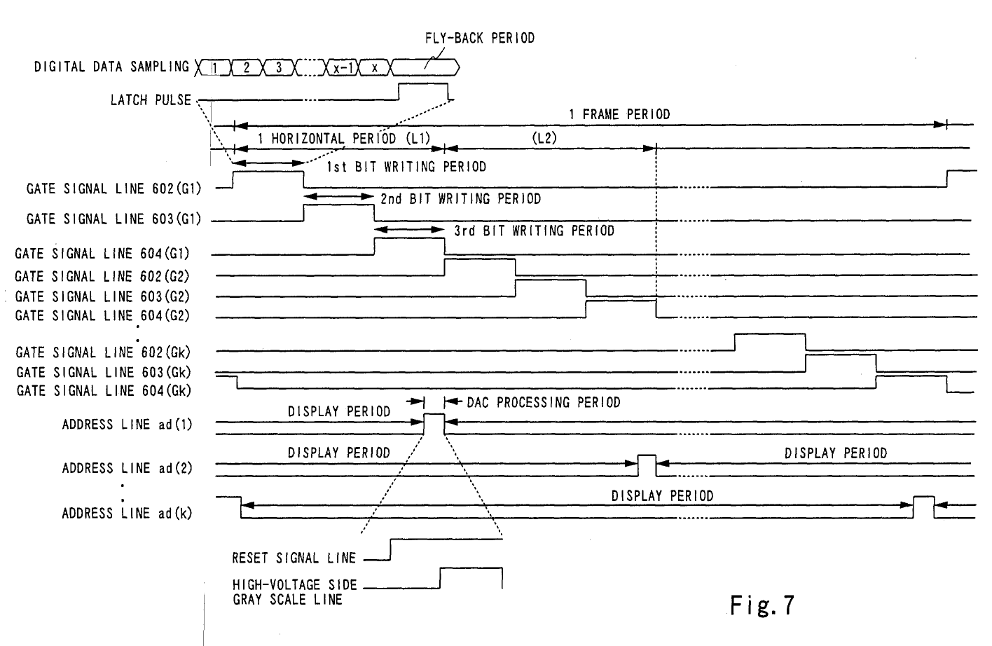

The method of driving the light-emitting device having the thus constituted pixel unit will now be described by using a timing chart of FIG. 7.

This embodiment uses the timing chart illustrating the operation of when there is used the DAC of the constitution shown in FIG. 5. However, the constitution of the DAC that can be used for the light-emitting device of the invention is not limited to the one shown in FIG. 5, and the DAC of any known constitution can be freely used.

First, described below is the operation until when the digital signals are held by the storage circuits in the pixels.

In the source signal line drive circuit, digital signals of an amount of a horizontal period are held (digital signal sampling period) according to a sampling pulse output from the shift register.

Thereafter, a latch pulse is input during the fly-back period, and the digital signals transferred to the second latch circuit are input to the source signal line.

Here, one horizontal period can be divided into three periods, i.e., a first bit writing period, a second bit writing period and a third bit writing period.

During the first bit writing period, a digital signal (D3) is input to a source signal line due to a bit selection signal. At this moment, a signal is input to the gate signal line 602(G1), and the switching TFT 608(G1) connected to the above gate signal line is rendered conductive. Thus, the digital signal (D3) of the first bit is written into the storage circuit (M)605(1).

Next, in the second bit writing period, a digital signal (D2) is input to a source signal line due to a bit selection signal. At this moment, a signal is input to the gate signal line 603(G1), and the switching TFT 609(G1) connected to the above gate signal line is rendered conductive. Thus, the digital signal (D2) of the second bit is written into the storage circuit (M)606(1).

Next, in the third bit writing period, a digital signal (D1) is input to a source signal line due to a bit selection signal. At this moment, a signal is input to the gate signal line 603(G1), and the switching TFT 609(G1) connected to the above gate signal line is rendered conductive. Thus, the digital signal (D1) of the third bit is written into the storage circuit (M)607(i).

The digital signals thus written are converted (DAC processing period) into analog signals through the DAC 611 by utilizing a period of from the writing period of the third bit to the DAC processing period in the next horizontal period.

Next, the operation of the above DAC processing period will be described with reference to FIG. 6B and FIG. 7.

In FIG. 6B like in FIG. 3B, SW(1) to SW(3) and SW(A) are constituted by TFTs and address lines ad(1) to ad(k). The address lines ad(1) to ad(k) are used for selecting input of signals from the storage circuits (605(1 to k), 606(1 to k), 607(1 to k)) possessed by the pixels 600(1) to 600(k) to the DAC 611 and output of the signals from the DAC 611 to the capacitors (Cs)614(1 to k) and to the gate electrodes of the current-controlling TFTs 616(1 to k) possessed by the pixels 600(1) to 600(k).

The timing chart of FIG. 7 illustrates the operation of when the TFTs connected to the address line are all of the n-channel type. The TFTs, however, may be either the p-channel type or the n-channel type. Here, however, the TFTs connected to the same address line must have the same polarity.

When one address line ad(1) is selected, here, the other address lines ad(2) to ad(k) are not selected.

When the first horizontal period (L1) ends, the gate electrode is connected to the address line ad(1), and digital signals are input to the DAC 611 from the storage circuits of the selected pixel through the TFTs that are rendered conductive.

Here, in the DAC shown in FIG. 5, a signal res is input to the reset signal line 552. Thereafter, the potential of the high-voltage side gray scale power source line 554 changes into V_{H}. Thus, the digital signals input to the DAC are converted into analog signals. The analog signals are input to the capacitor 614(1 to k) and to the gate electrode of the current-controlling TFT 616(1 to k) of the selected pixel. The amount of current flowing into the current-controlling TFT is controlled depending upon the voltage of the analog signal that is applied to the gate electrode of the current-controlling TFT in each pixel, and the thus controlled current flows into the light-emitting element to express the gray scale of the light-emitting element.

Next, when the digital signal sampling period ends in the second horizontal period (L2), the address line ad(2)is selected, but other address lines ad(1), ad(3) to ad(k) are not selected. At this moment, signals are input to the DAC 611 from the storage circuits of the selected pixel through the TFTs of which the gate electrodes are connected to the address line ad(2).

Next, a signal res is input to the reset signal line 552. Thereafter, the potential of the high-voltage side gray scale power source line 654 changes into V_{H}. Thus, the digital signals input to the DAC 611 are converted into analog signals. The analog signals are input to the capacitor (Cs)614 and to the gate electrode of the current-controlling TFT 616 of the selected pixel. The amount of current flowing into the current-controlling TFT is controlled depending upon the analog signal that is input, and the thus controlled current flows through the light-emitting element to control the brightness of the light-emitting element. In this embodiment which uses 3-bit signals, the brightness is obtained in eight steps of from 0 to 7.

The same operation is repeated for a plurality of horizontal periods for all address lines, whereby all of the digital signals stored in the storage circuits of all pixels 600(1) to 600(k) of the block 613 are converted into analog signals, and the brightness of the light-emitting elements is controlled by using the thus converted analog signals.

The above operation is similarly conducted for all blocks to convert the digital signals held by all pixels into analog signals.

In this embodiment sharing the DAC, only one DAC may be selected on one line (one horizontal period). Accordingly, the switches SW(1) to SW(3) and SW(A) need not be changed over a plural number of times during the DAC processing period in one horizontal period. Therefore, no high-speed operation needs to be executed for selecting them.

[Embodiment 3]

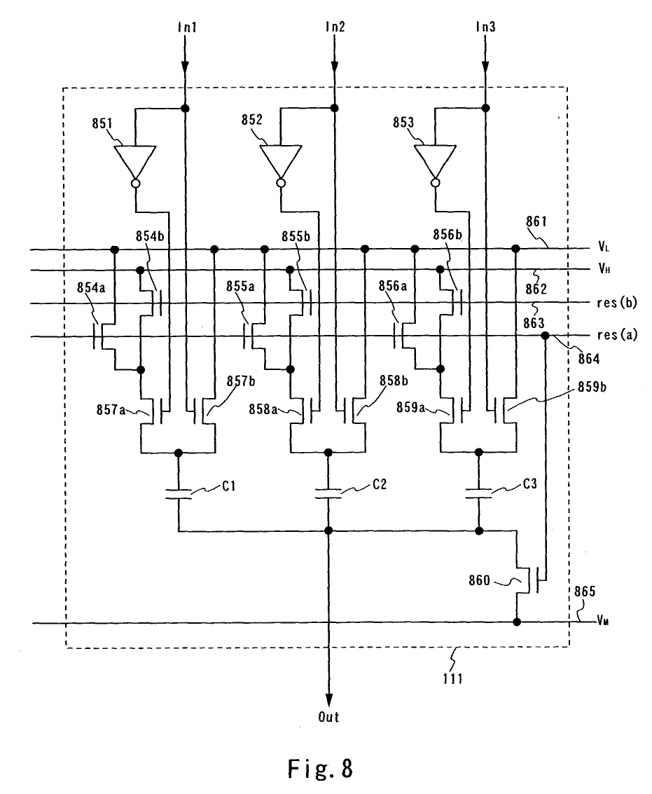

This embodiment deals with the DAC that can be used for the light-emitting device of the invention but having a structure different from that of FIG. 5. The embodiment will now be described with reference to FIG. 8.

In FIG. 8, terminals in1 to in3 correspond to the input of 3-bit digital signals, and terminal out corresponds to the output terminal for producing the analog signals after converted through the DAC.

In FIG. 8, the DAC is constituted by inverters 581 to 853, TFTs 854a to 856a, TFTs 854b to 856b, a TFT 860, capacitors C1 to C3, a low-voltage side gray scale power source line 861, a high-voltage side gray scale power source line 862, an inverted reset signal line (res(b)) 863, a reset signal (res(a)) 864, and an intermediate-voltage side gray scale power source line 865. The signal res(b) on the inverted reset signal line and the reset signal res(a) have opposite polarities.

Here, the TFTs 854a to 856a, TFTs 854b to 856b and TFT 860 may be either of the n-channel type or the p-channel type. However, those connected to the same reset signal line or the same inverted reset signal line must have the same polarity. Further, the TFTs 857a to 859a and TFTs 857b to 859b may be either the n-channel type or the p-channel type, but must have the same polarity.

First, the TFT 860 is rendered conductive due to a signal res input to the reset signal line 864, and the potential of the capacitors C1 to C3 on the side (hereinafter referred to as the opposing electrode side) connected to the terminal out, is fixed to a potential V_{M} of the intermediate-voltage side gray scale power source line 865. At the same time, the TFTs 854a to 856a are rendered conductive, the TFTs 854b to 856b are rendered non-conductive, and the potential V_{L} of the low-voltage side gray scale power source line 861 is applied to the electrodes of the capacitors C1 to C3 on the side opposite to the terminal out. Here, no signal is written into the capacitors C1 to C3 even when digital signals are input to in1 to in3.

Next, the signal res of the reset signal line 864 varies, the switch 860 turns off, and the fixed potential of the capacitors C1 to C3 on the side of the terminal out is reset. At the same time, the potential V_{H} of the high-voltage side gray scale power source line 862 is input to the source regions or the drain regions of the TFTs 857a to 859a through TFTs 854b to 856b. On the other hand, the potential V_{L} of the low-voltage side gray scale power source line 861 is input to the source regions or the drain regions of the TFTs 857b to 859b.

The TFTs 857a to 859a and the TFTs 857b to 859b are rendered conductive or nonconductive depending upon the signals input to the terminals in1 to in3, and the potential V_{H} of the high-voltage side gray scale power source line 862 or the potential V_{L} of the low-voltage side gray scale power source line 861 is applied to the electrodes of the capacitors C1 to C3. The values of the capacitors C1 to C3 are set depending upon the bits.

The voltage on the opposing electrode side varies depending upon the voltage applied to the capacitors C1 to C3, and the output voltage varies. Namely, analog signals corresponding to the digital signals input to in1 to in3 are produced from the terminal out.

In the DAC of the above constitution, the reference potential is divided by the capacitors C1 to C3 to express a variety of gray scales. Further, the DAC of the above capacity division type is disclosed in a literature (AML CD99, Digest of Technical Papers, pp. 29-32).

In the foregoing was described the DAC for converting the 3-bit digital signals into analog signals. The embodiment, however, can also be applied even to a DAC that converts digital signals of different number of bits into analog signals.

Further, not only the DAC of the above structure but also the DAC of any known structure can be freely used for the invention. For example, there may be used a DAC of the resistance division type dividing the reference voltage by using resistors.

The DAC described in this embodiment can be used in free combination with the light-emitting device of the invention described in the embodiment 1 or the embodiment 2.

[Embodiment 4]

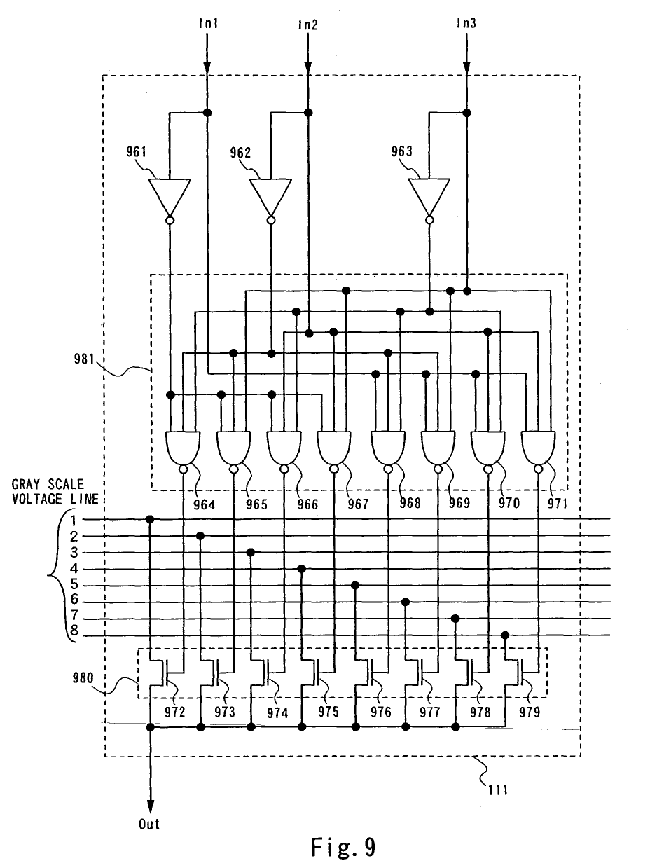

This embodiment deals with a system for selecting a plurality of gray scale voltage lines in the DAC that can be used in the invention. A preferred example will now be described with reference to FIG. 9.

In FIG. 9, terminals in1 to in3 correspond to the input of 3-bit digital signals, and terminal out corresponds to the output terminal for producing the analog signals after being converted.

In FIG. 9, the DAC is constituted by inverters 961 to 963, NAND circuits 964 to 971, switching TFTs 972 to 979, and gray scale voltage lines 1 to 8.

Here, the switching TFTs 972 to 979 may be either of the p-channel type or the n-channel type. However, the switching TFTs 972 to 979 must all have the same polarity.

When 3-bit digital video signals are to be processed, there are used eight gray scale voltage lines to which are connected switching TFTs, respectively. Inputs to the terminals in1 to in3 work to selectively drive the switching TFTs 972 to 979 in the switch 980 via a decoder 981 constituted by the NAND circuits 964 to 971. Thus, a gray scale voltage line corresponding to the digital signals input to in1 to in3 is selected out of the gray scale lines 1 to 8, and the potential of the selected gray scale voltage line is produced. There may be used a transmission gate instead of the switch 980.

Though the embodiment has described the DAC for converting 3-bit digital signals into analog signals, the embodiment can be further applied even to the DAC that converts digital signals having different bit numbers into analog signals.

Further, not only the DAC of the above structure but also the DAC of any known structure can be freely used for the invention.

The DAC described in this embodiment can be used in free combination with the light-emitting device of the invention described in the embodiment 1 or the embodiment 2.

[Embodiment 5]

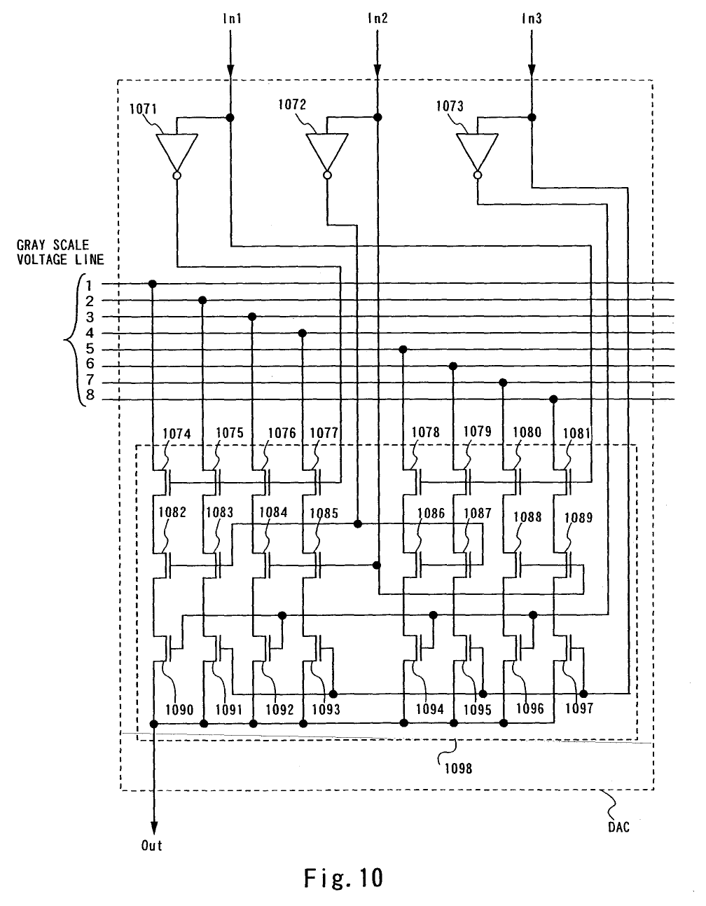

This embodiment deals with a system for selecting a plurality of gray scale voltage lines in the DAC that can be used in the invention, and describes the DAC of a structure different from the one described in the embodiment 4 with reference to FIG. 10.

In FIG. 10, the DAC is constituted by inverters 1071 to 1073, TFTs 1074 to 1097, and gray scale voltage lines 1 to 8.

Here, a decoder/switch 1098 is constituted by TFTs 1074 to 1097. The TFTs 1074 to 1097 constituting the decoder/switch 1098 may be either the n-channel type or the p-channel type. However, they all must have the same polarity.

The signals input through the input terminals in1 to in3 select any one of gray scale voltage lines 1 to 8 depending upon the digital signals that are input to the decoder/switch 1098. The potential of the selected gray scale voltage line is output as an analog signal from the terminal out.

The DAC of this embodiment is of the system for selecting a gray scale voltage line like the one described in the embodiment 4 (FIG. 9). The DAC of the embodiment 4 (FIG. 9) contains many numbers of constituent elements occupying increased areas in the pixels. In the DAC of this embodiment, however, the switch is connected in series, so that the decoder also serves as a switch to decrease the number of elements.

Though the embodiment has described the DAC for converting 3-bit digital signals into analog signals, the embodiment can be further applied even to the DAC that converts digital signals having different bit numbers into analog signals.

Further, not only the DAC of the above structure but also the DAC of any known structure can be freely used for the invention. The DAC described in this embodiment can be used in free combination with the light-emitting device of the invention described in the embodiment 1 or the embodiment 2.

[Embodiment 6]

This embodiment deals with a method of writing into the storage circuits in the pixels by successively driving the lines by using a source signal line drive circuit of the invention without the second latch circuit.

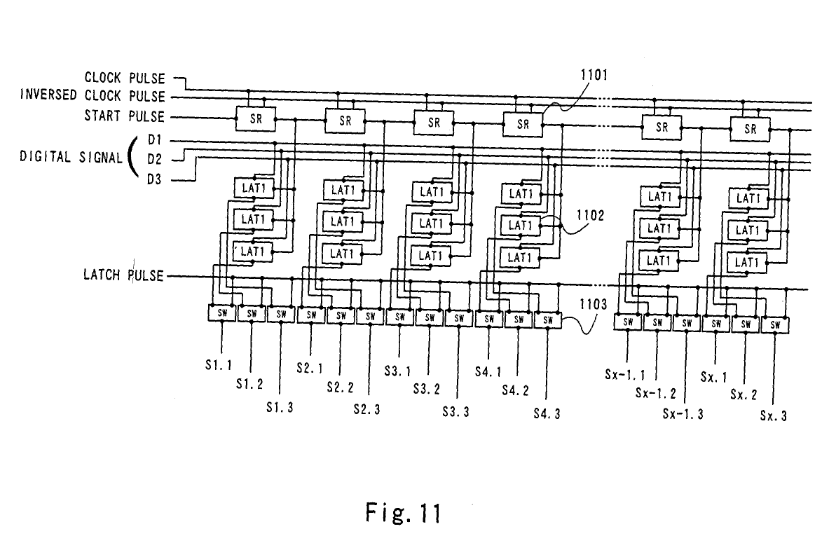

FIG. 11 illustrates the circuit constitution of the source signal line drive circuit in the light-emitting device of this embodiment. This circuit is for 3-bit digital signals, and includes shift registers 1101, latch circuits 1102 and switching circuits 1103. The signals from the source signal line drive circuit are input to source signal lines S1.1 to Sx.1, source signal lines S1.2 to Sx.2 and source signal lines S1.3 to Sx.3.

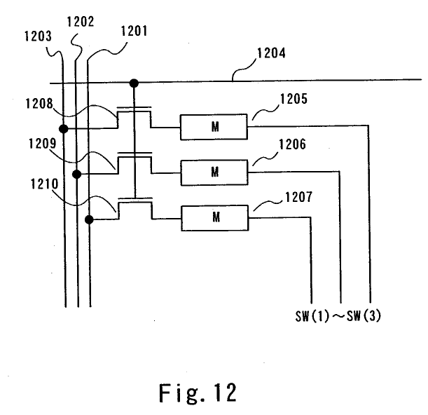

FIG. 12 illustrates a circuit constitution of a pixel having source signal lines S1.1, S1.2 and S1.3 among the above source signal lines. The three source signal lines S1.1, S1.2 and S1.3 correspond to source signal lines 1201 to 1203 of FIG. 12.

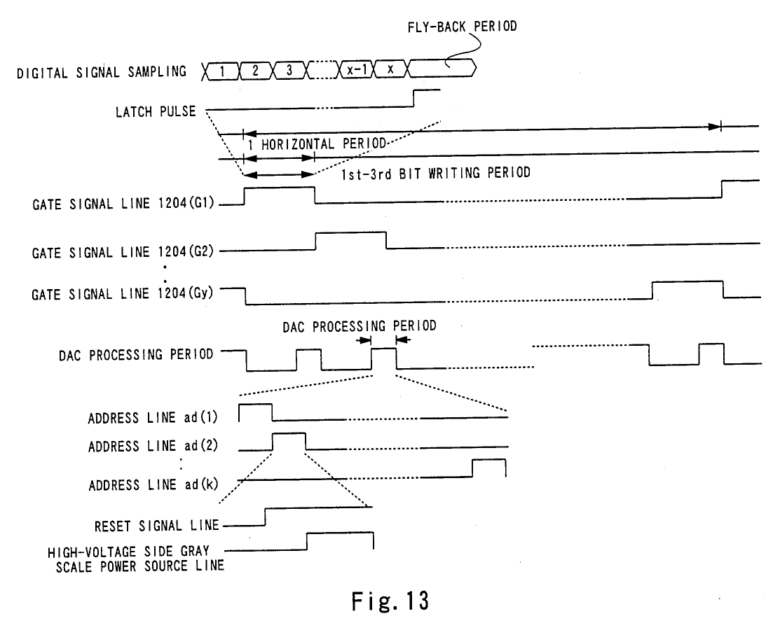

A method of driving the circuit constitution of this embodiment will be further described by using a timing chart illustrated in FIG. 13.

The operation is the same as that of the embodiment 1 until a sampling pulse is output from the shift register 1101 and a digital signal is held by the latch circuit 1102 in response to the sampling pulse, and is not described here.

This embodiment has a switching circuit 1103 between the latch circuit 1102 and the storage circuits in the pixel 1104. Even when the digital signals have been completely held by the latch circuit, therefore, the writing into the storage circuits in the pixels is not readily started. The switching circuit 1103 remains closed until the period for holding the digital signals ends and, during this period, the digital signals are held by the latch circuit.

When the holding of digital signals of an amount of one horizontal period is completed, a latch pulse is input during the fly-back period, whereby the switching circuits 1103 are opened at one time, and the digital signals held by the latch circuits 1102 are sent onto the source signal lines S1.1 to Sx.1, source signal lines S1.2 to Sx.2 and source signal lines S1.3 to Sx.3 so as to be written into the storage circuits in the pixels.

In the source signal line drive circuit of the constitution of this embodiment, the 3-bit digital signals are simultaneously input to a row of pixels. In this embodiment, the writing into the storage circuits of the pixels starts right after the end of the latching operation (digital signal sampling period) in the first stage. Concretely speaking, a pulse is input to the gate signal line 1204, the switching TFTs 1208 to 1210 are rendered conductive, and the signals are ready to be written into the storage circuits 1205 to 1207. The digital signals for every bit held by the latch circuits 1102 are simultaneously written through three source signal lines 1201 to 1203.

While the digital signals held by the latch circuits are being written into the storage circuits in the first stage, the digital signals in the next stage are held by the latch circuits according to sampling pulses. Thus, the signals are successively written into the storage circuits.

Thus, the digital signals of a row of pixels are output to end one horizontal period. A DAC processing period is provided in the fly-back period in one horizontal period.

The operation for converting the digital signals held by the storage circuits in the pixels into the analog signals, may be conducted in the same manner as that of the embodiment 1, and is not described here.

The above method, too, makes it easy to successively drive the lines for writing by using the source signal line drive circuit without having the traditionally employed second latch circuit.

This embodiment can be put into practice in free combination with the constitution of the invention of the embodiment 1 to the embodiment 5.

[Embodiment 7]

This embodiment deals with a method of operating the source signal line drive circuit at a speed three times as faster as the conventional speed, the source signal line drive circuit having a latch circuit for one bit only, in order to input the digital signals to the source signal line drive circuit in order of a first-bit digital signal, a second-bit digital signal and a third-bit digital signal during a line period.

In the embodiment 1, the digital signals are sampled only one time in one horizontal period as illustrated in the timing chart of FIG. 4, and the digital signals corresponding to the bits are successively output in response to bit selection signals. In this embodiment, however, the sampling of digital signals must be repeated three times in one horizontal period.

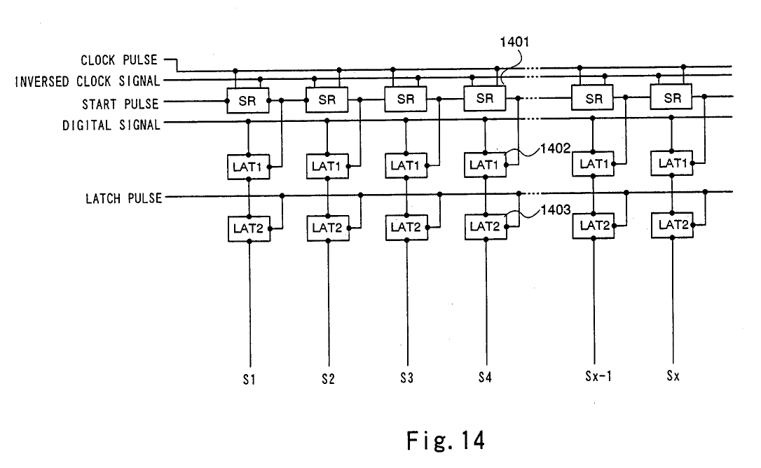

In FIG. 14, the source signal line drive circuit is constituted by shift registers (denoted by SR in the drawing) 1401, first latch circuits (denoted by LAT1 in the drawing) 1402 and second latch circuits (denoted by LAT2 in the drawing) 1403.

The first latch circuits (LAT1) 1402 sample the digital signals in response to clock pulses and inverted clock pulses input to the shift registers. Here, the first latch circuits (LAT1) 1402 hold the first-bit digital signals. Then, a latch pulse is input, and the first-bit digital signals are transferred to the second latch circuits (LAT2) 1403. Thus, the signals are output to the source signal lines S1 to Sx. Namely, the first-bit signals are stored in the storage circuits in each pixel (first bit writing period).

In the first latch circuits (LAT1) 1402, the sampling of the second-bit signals starts after the first-bit signals are transferred to the second latch circuits. Similarly, the second-bit signals are transferred to the second latch circuits due to a latch pulse and are output to the source signal lines S1 to Sx. Thus, the second-bit signals are stored in the storage circuits of the pixels (second bit writing period).

In the first latch circuits (LAT1) 1402, further, the sampling of the third-bit signals starts after the second-bit signals are transferred to the second latch circuits. The sampling of the third-bit signals ends, and the signals are transferred to the second latch circuits and are output to the source signal lines S1 to Sx. Thus, the third-bit signals are stored in the storage circuits of the pixels (third bit writing period).

Thus, one horizontal period ends.

After the third-bit digital signals are transferred to the second latch circuits in sone horizontal period, the first latch circuits (LAT1) 1402 start sampling the first-bit digital signals in the next horizontal period.

Here, in the DAC processing period provided in the fly-back period of the shift register of from the end of the sampling of the third-bit digital signals until the start of sampling the first-bit digital signals in the next horizontal period, the digital signals stored in the storage circuits of the pixels are converted into analog signals. The operation of the DAC processing period is the same as that of the embodiment 1, and is not described here.

This system must be provided with an external P/S (parallel/serial) converter circuit for converting the digital signals input to the source signal line drive circuit into signals that are arranged in order of bits. The source signal line drive circuit, however, can be fabricated in a small size.

The constitution of this embodiment can be put into practice in free combination with the embodiment 1 or the embodiment 2.

[Embodiment 8]

In this embodiment, a case where a signal is rewritten by one gate signal line unit in the light emitting device of the present invention will be described.

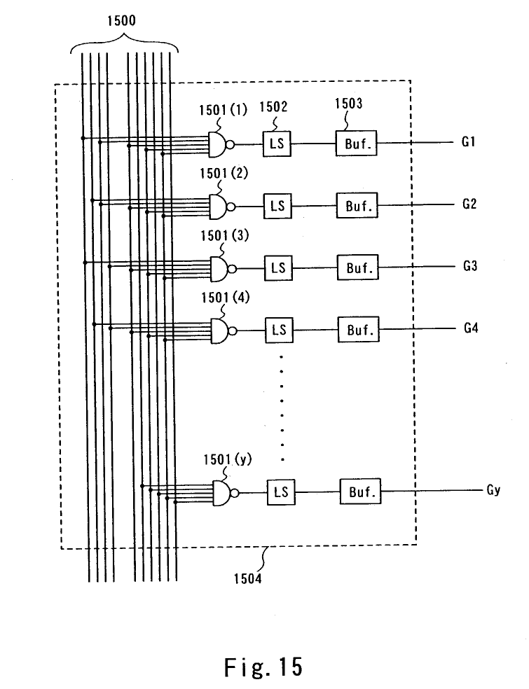

In this case, it is preferable that an address decoder is used as a gate signal line drive circuit. An example in which the address decoder is used as the gate signal line drive circuit is shown in FIG. 15.

A gate signal line drive circuit that outputs signals at a gate signal line connected to a switching TFTs in respective pixels will be described in this embodiment. Incidentally, a configuration of the gate signal line drive circuit is applied to a case where respective pixels include a plurality of gate signal lines corresponding to the number of bits.

In FIG. 15, a gate signal line drive circuit 1504 is constituted of an address line 1500, NAND circuits 1501(1) to 1501(y), a level shifter (denoted by “LS” in the drawing) 1502, and a buffer (denoted by “Buf.” in the drawing) 1503. And the gate signal line drive circuit can output signals to gate signal lines G1 to Gy.

In addition, circuits as disclosed in a literature (Japanese Patent Application Laid-open No. Hei 8-101609) etc. may be used as the address decoder.

Further, it is possible that the signals is partly rewritten by one line of source signal line by using the address decoder or the like to a source signal line drive circuit.

This embodiment can be implemented by being freely combined with the composition shown in Embodiment 1 through Embodiment 7 of the present invention.

[Embodiment 9]

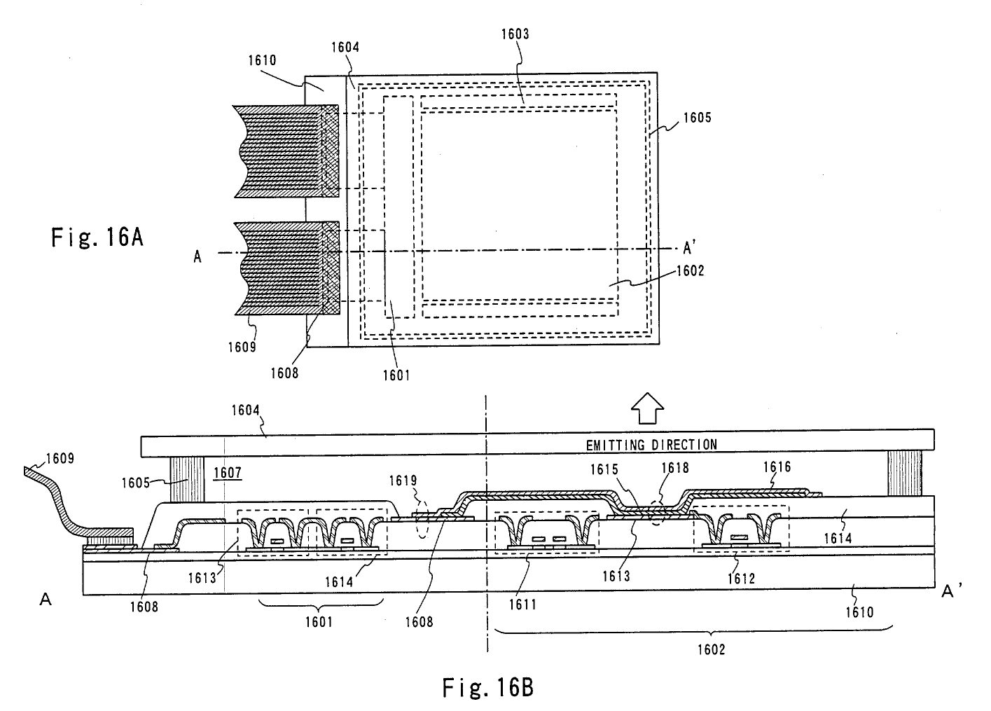

In this embodiment, a structure of the light emitting device of the present invention will be described with reference to FIGS. 16A and 16B.

FIG. 16A is a top view of the light emitting device, and FIG. 16B is a sectional view taken along a line A-A′ of FIG. 16A. Reference number 1601 represents a source signal line drive circuit, which is illustrated by a dotted line; 1602, a pixel portion; 1603, a gate signal line drive circuit; 1604, an encapsulating substrate; and 16O5, a sealant. Inside surrounded by the sealant 1605 is an empty space 1607.

Note that a connection wiring 1608 represents wiring for transmitting signals inputted to the source signal line drive circuit 1601 and the gate signal line drive circuit 1603. The connection wiring 1608 receives video signals or clock signals from a flexible print circuit (FPC) 1609, which will be an external input terminal. Only the FPC is illustrated, but it is electrically connected to an external electric power.

The following will describe a sectional structure, referring to FIG. 16B. The driver circuits and the pixel portion are formed on the substrate 1610, but the source signal line drive circuit 1601 as one of the drive circuits and the pixel portion 1602 are shown in FIG. 16B.

In the source signal line drive circuit 1601, a CMOS circuit wherein an n-channel type TFT 1613 and a p-channel type TFT 1614 are combined is formed. The TFTs constituting the drive circuit may be composed of known CMOS circuits, PMOS circuits or NMOS circuits. In this embodiment, a driver-integrated type, wherein the drive circuit is formed on the substrate, is illustrated, but the driver-integrated type may not necessarily be adopted. The driver may be fitted not on the substrate but to the outside.

The pixel portion 1602 is composed of a plurality of pixels including a switching TFT 1611 that is inputted video signals from the source signal line drive circuit, a current control TFT 1612 that is connected with the switching TFT 1611 and has a function of controlling luminous of a light emitting element, and a first electrode (anode) 1613 that is electrically connected to a drain of the current control TFT 1612.

On the both sides of the first electrode 1613, insulating films 1614 are formed, and an organic compound layer 1615 is formed right on the first electrode 1613. Furthermore, a second electrode 1616 is formed on the organic compound layer 1615. In this way, a light emitting element 1618 composed of the first electrode (anode) 1613, the organic compound layer 1615 and the second electrode (cathode) 1616 is formed.

An auxiliary electrode 1617 is formed on the second electrode (cathode) 1616. The auxiliary electrode 1617 is electrically connected to a connection wiring 1608 and further electrically connected to an external electric power through a FPC 1609.

In order to encapsulate the light emitting element 1618 formed on the substrate 1610 airtightly, the encapsulating substrate 1604 is adhered to the substrate 1610 with the sealant 1605. A spacer made from a resin film may be set up to keep a given interval between the encapsulating substrate 1604 and the light emitting element 1618. An inert gas such as nitrogen is filled into the space 1607 inside the sealant 1605. As the sealant 1605, an epoxy resin is preferably used. The sealant 1605 is desirably made from a material through which moisture or oxygen is transmitted as slightly as possible.

Note that the light emitting device shown in this embodiment includes a structure (top emission type) in which the second electrode (cathode) 1616 is made from a translucent material, and light generated in the organic compound layer 1615 is transmitted through the second electrode (cathode) 1616, and then, emitted from the encapsulating substrate 1604 side.

However, the light emitting device of the present invention is not limited to this structure, and the light emitting device can be composed of a structure (bottom emission type) in which the second electrode 1616 is made from a translucent material, light generated in the organic compound layer 1615 is transmitted through the first electrode 1613, and then, emitted from the substrate 1610 side. In this case, it is not necessary that the encapsulating substrate 1604 be made from a translucent material. The encapsulating substrate 1604 is preferably made from a light shielding material. Further, in a part of the encapsulating substrate 1604, a drying agent 1621 is provided in the space enclosed with the encapsulating substrate 1604 and a film 1620. Therefore, the drying agent can absorb moisture in the space 1607 through the film 1620.

Further, it is possible that the first electrode is made from a cathode material and the second electrode is made from an anode material in the present invention.

As a material of the encapsulating substrate 1604 used in this embodiment, materials such as a plastic substrate made from FRP (fiber glass-reinforced plastic), PVF (polyvinyl fluoride), mylar, polyester or acrylic resin can be employed in addition to a glass substrate and a quartz substrate.

As described above, the light emitting element is airtightly encapsulated in the space 1607, so that the light emitting element can be completely shut out from the outside and materials promoting deterioration of the organic compound layer, such as moisture and oxygen, can be prevented from invading this layer from the outside. Consequently, the light emitting device can be made highly reliable.

[Embodiment 10]

In this embodiment, an example of a structure of a memory circuit provided in a pixel of the light emitting device of the present invention will be described.

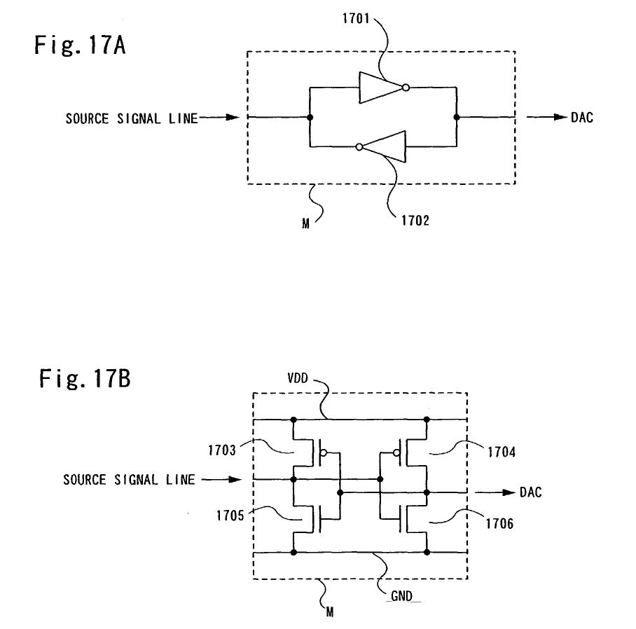

FIG. 17A shows one example of the memory circuit formed in each pixel of the light emitting device of the invention. In FIG. 17A, a region surrounded by the dotted line corresponds to the memory circuit (denoted by “M” in the drawing). The memory circuit M is composed of inverters 1701 and 1702. The memory circuit shown in this embodiment uses a static random access memory (static RAM: SRAM) that utilizes a flip-flop.

FIG. 17B shows a detailed example of the memory circuit illustrated in FIG. 17A. ATFT 1703 and a TFT 1704 are p-channel type TFTs, respectively. On the other hand, a TFT 1705 and a TFT 1706 are n-channel type TFTs, respectively. Further, a VDD denotes a power source line and a GND denotes a ground line.

This embodiment can be put into practice in free combination with the composition of the invention of Embodiment 1 through Embodiment 10.

[Embodiment 11]

In Embodiment 10, a static random access memory (static RAM: SRAM) is used for the memory circuit in the pixel portion of the light emitting device of the present invention. However, the memory circuit is not limited to the SRAM in this embodiment. A dynamic random access memory (dynamic RAM: DRAM) or the like can be given as other memory circuits employable by the pixel portion in the light emitting device of the present invention.

Still another format of a memory circuit that can be used to constitute a pixel portion in a light emitting device of the present invention is, though not shown in the drawing, a ferroelectric random access memory (ferroelectric RAM: FeRAM). The FeRAM is a non-volatile memory having the same level of writing speed as the SRAM and the DRAM. Characteristics of FeRAM, including low writing voltage, can be utilized to further reduce power consumption of the light emitting device of the present invention. A flash memory may also be used to constitute the memory circuits of the present invention.

This embodiment can be put into practice in free combination with the constitution of Embodiment 1 through Embodiment 10.

[Embodiment 12]

A light emitting device using a light emitting element has superior visibility to a liquid crystal display device in bright locations because it is of a self-luminous type, and moreover viewing angle is wide. Accordingly, various electronics can be completed by utilizing the light emitting device of the present invention.

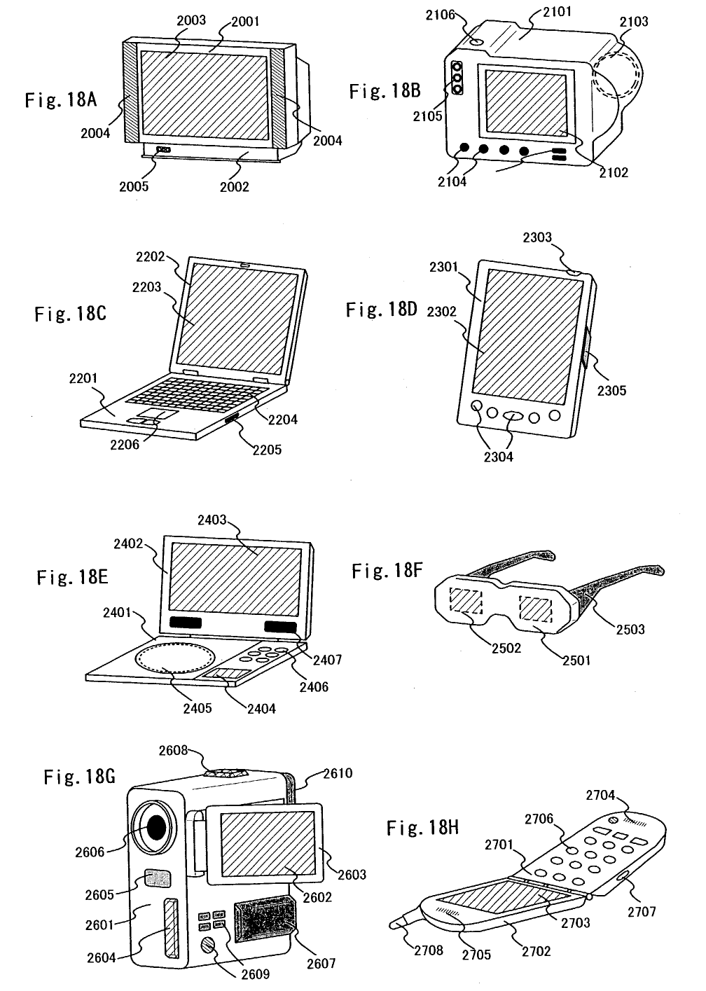

The following can be given as examples of such electronics: a video camera; a digital camera; a goggle type display (head mounted display); a car navigation system; an audio reproducing device (such as a car audio system, an audio compo system); a laptop computer; a game equipment; a portable information terminal (such as a mobile computer, a cellular phone, a mobile game equipment or an electronic book etc.); and an image reproducer provided with a recording medium (specifically, a device which reproduces a recording medium and is provided with a display which can display those images, such as a digital versatile disk (DVD) etc.). In particular, because portable information terminals are often viewed from a diagonal direction, the wideness of the field of vision is regarded as very important. Thus, it is preferable that the light emitting device including a light emitting element is employed. Examples of these electronics are shown in FIGS. 18A to 18H.

FIG. 18A illustrates a display device which includes a casing 2001, a support table 2002, a display portion 2003, a speaker portion 2004, a video input terminal 2005 or the like. The display device of the present invention is applicable to the display portion 2003. The light emitting device is of the self-emission-type and therefore requires no backlight. Thus, the display portion thereof can have a thickness thinner than that of the liquid crystal display device. The display device is including the entire display device for displaying information, such as a personal computer, a receiver of TV broadcasting and an advertising display.

FIG. 18B illustrated a digital still camera which includes a main body 2101, a display portion 2102, an image receiving portion 2103, an operation key 2104, an external connection port 2105, a shutter 2106, or the like. The light emitting device in accordance with the present invention is used as the display portion 2102, thereby the digital still camera of the present invention completing.

FIG. 18C illustrates a lap-top computer which includes a main body 2201, a casing 2202, a display portion 2203, a keyboard 2204, an external connection port 2205, a pointing mouse 2206, or the like. The light emitting device in accordance with the present invention is used as the display portion 2203, thereby the lap-top computer of the present invention completing.

FIG. 18D illustrated a mobile computer which includes a main body 2301, a display portion 2302, a switch 2303, an operation key 2304, an infrared light port 2305, or the like. The light emitting device in accordance with the present invention is used as the display portion 2302, thereby the mobile computer of the present invention completing.

FIG. 18E illustrates a portable image reproduction device including a recording medium (more specifically, a DVD reproduction device), which includes a main body 2401, a casing 2402, a display portion A 2403, another display portion B 2404, a recording medium (DVD or the like) reading portion 2405, an operation key 2406, a speaker portion 2407 or the like. The display portion A 2403 is used mainly for displaying image information, while the display portion B 2404 is used mainly for displaying character information. The light emitting device in accordance with the present invention is used as these display portions A 2403 and B 2404, thereby the image reproduction device of the present invention completing. The image reproduction device including a recording medium further includes a domestic game machine or the like.

FIG. 18F illustrates a goggle type display (head mounted display) which includes a main body 2501, a display portion 2502, arm portion 2503 or the like. The light emitting device in accordance with the present invention is used as the display portion 2502, thereby the goggle type display of the present invention completing.

FIG. 18G illustrates a video camera which includes a main body 2601, a display portion 2602, a casing 2603, an external connecting port 2604, a remote control receiving portion 2605, an image receiving portion 2606, a battery 2607, a sound input portion 2608, an operation key 2609, an eyepiece portion 2610, or the like. The light emitting device in accordance with the present invention is used as the display portion 2602, thereby the video camera of the present invention completing.

FIG. 18H illustrates a cellular phone which includes a main body 2701, a casing 2702, a display portion 2703, a sound input portion 2704, a sound output portion 2705, an operation key 2706, an external connecting port 2707, an antenna 2708, or the like. The light emitting device in accordance with the present invention is used as the display portion 2703, thereby the mobile phone of the present invention completing. Note that the display portion 2703 can reduce power consumption of the mobile telephone by displaying white-colored characters on a black-colored background.

When the brighter luminance of light emitted from an electric field emission material becomes available in the future, the light emitting device in accordance with the present invention will be applicable to a front-type or rear-type projector in which light including output image information is enlarged by means of lenses or the like to be projected.

The aforementioned electronics is more likely to be used for display information distributed through a telecommunication path such as Internet, a CATV (cable television system), and in particular likely to display moving picture information. The light emitting device is suitable for displaying moving pictures since the electric field emission material can exhibit high response speed.

A portion of the light emitting device that is emitting light consumes power, so it is desirable to display information in such a manner that the light emitting portion therein becomes as small as possible. Accordingly, when the light emitting device is applied to a display portion which mainly displays character information, e.g., a display portion of a portable information terminal, and more particular, a cellular phone or a sound reproduction device, it is desirable to drive the light emitting device so that the character information is formed by a light emitting portion while a non-emission portion corresponds to the background.

As set forth above, the present invention can be applied variously to a wide range of electronics in all fields. The electronics in this embodiment can be obtained by utilizing the light emitting device manufactured by implementing Embodiment 1 through Embodiment 11.

This invention provides a light-emitting device capable of decreasing the consumption of electric power by arranging storage circuits in each pixel, and a method of driving the same.

According to the invention, further, a plurality of pixels share a D/A converter circuit which works to convert the digital signals stored in the storage circuits in the pixels into analog signals and, then, to input the analog signals to the capacitors in the pixels and to the gate electrodes of the current feeder lines. Therefore, the DAC occupies a decreased area in the pixel unit offering such an advantage as an increased numerical aperture, and enabling more storage circuits to be arranged than those of the prior art.

What is claimed is:

1. A light-emitting device for expressing a gray scale by using digital signals of n bits (n is a natural number of not smaller than 2), wherein:
a pixel unit in the light-emitting device is divided into blocks each containing pixels of the number of k (k is a natural number of not smaller than 2);
a D/A converter circuit is provided for each block;
each of the pixels of the number of k includes storage circuits of the number of n, a TFT and a light-emitting element;
the D/A converter circuit is connected to the storage circuits of the number of n and to the TFTs possessed by the pixels of the number of k through switching means;
and wherein provision is made of:
means for storing digital signals of n bits in the storage circuits of the number of n;
means for selecting a pixel out of the pixels of the number of k, and for inputting digital signals of n bits stored in the storage circuits of the one pixel to the D/A converter circuit; and
means for inputting an analog signal output from the D/A converter circuit to a gate electrode of the TFT in one pixel;
the TFT and the light-emitting element being connected together.

2. A light-emitting device according to claim 1, wherein the pixels of the number of k, the source signal line drive circuit and the gate signal line drive circuit are formed on the same substrate.

3. A light-emitting device according to claim 1, wherein the storage circuits of the number of n are static memories (SRAMs).

4. A light-emitting device according to claim 1, wherein the light-emitting device is incorporated into an electronic appliance selected from the group consisting of a video camera; a digital camera; a goggle type display; a car navigation system; an audio reproducing device; a laptop computer; a game equipment; and a portable information terminal; and an image reproducer provided with a recording medium.

5. A light-emitting device for expressing a gray scale by using digital signals of n bits (n is a natural number of not smaller than 2), wherein:
the device is divided into blocks each containing pixels of the number of k (k is a natural number of not smaller than 2);
a gate signal line drive circuit and a source signal line drive circuit are formed therein;
a D/A converter circuit is provided for each of the blocks;
each of the pixels of the number of k includes storage circuits of the number of n, first TFTs of the number of n, a second TFT and a light-emitting element;
the D/A converter circuit is connected to the storage circuits of the number of n and to the second TFTs possessed by the pixels of the number of k through switching means;
the first TFTs of the number of n are connected to the storage circuits of the number of n, respectively;
the first TFTs of the number of n are rendered conductive by an output signal from the gate signal line drive circuit;
and wherein provision is made of:
means for inputting an output signal from the source signal line drive circuit to the storage circuits of the number of n through the first TFTs of the number of n;
means for selecting a pixel out of the pixels of the number of k, and for inputting the digital signals of n bits stored n the storage circuits of the number of n in the one pixel to the D/A converter circuit; and
means for inputting an analog signal output from the D/A converter circuit to a gate electrode of the second TFT in one pixel;
the second TFT and the light-emitting element being connected together.

6. A light-emitting device according to claim 5, wherein either the source signal line drive circuit or the gate signal line drive circuit has an address decoder, or both of them have an address decoder.

7. A light-emitting device according to claim 5, wherein the pixels of the number of k, the source signal line drive circuit and the gate signal line drive circuit are formed on the same substrate.

8. A light-emitting device according to claim 5, wherein the pixels of the number of k, the source signal line drive circuit and the gate signal line drive circuit are formed on the same substrate.

9. A light-emitting device according to claim 5, wherein the storage circuits of the number of n are static memories (SRAMs).

10. A light-emitting device according to claim 5, wherein the light-emitting device is incorporated into an electronic appliance selected from the group consisting of a video camera; a digital camera; a goggle type display; a car navigation system; an audio reproducing device; a laptop computer; a game equipment; and a portable information terminal; and an image reproducer provided with a recording medium.

11. A method of driving a light-emitting device with digital signals of n bits, the light-emitting device being divided into blocks each containing pixels of the number of k (k is a natural number of not smaller than 2), each pixel having storage circuits of the number of n, a TFT and a light-emitting element, and the light-emitting device further having a D/A converter circuit for each of the blocks, wherein:
digital signals of n bits are stored in the memory circuits of the number of n possessed by the pixels of the number of k;
one pixel is selected out of the pixels of the number of k, and the digital signals of n bits are input to the D/A converter circuit connected to the storage circuits of the number of n in one pixel through switching means; and
an analog signal output from the D/A converter circuit is input to a gate electrode of the TFT in the pixel connected to the D/A converter circuit through the switching means;
so that a predetermined current flows into the light-emitting element through the TFT in the pixel.

12. A method of driving a light-emitting device according to claim 11, wherein the digital signals of n bits are once stored in the storage circuits of the number of n, and, then, the digital signals of n bits are input to the D/A converter circuit from the storage circuits of the number of n in the pixel and the analog signal output from the D/A converter circuit is input to the gate terminal of the TFT in the pixel, which are repeated for a predetermined period of time.

13. A method of driving a light-emitting device with digital signals of n bits, the light-emitting device being divided into blocks each containing pixels of the number of k (k is a natural number of not smaller than 2), each pixel having storage circuits of the number of n, first TFTs of the number of n, a second TFT and a light-emitting element, and the light-emitting device further having a D/A converter circuit for each of the blocks, a gate signal line drive circuit and a source signal line drive circuit, wherein:
the first TFTs of the number of n possessed by the pixels of the number of k are rendered conductive by an output signal from the gate signal line drive circuit;
digital signals of n bits from the source signal line drive circuit are stored in the memory circuits of the number of n through the first TFTs of the number of n;
one pixel is selected out of the pixels of the number of k, and the digital signals of n bits are input to the D/A converter circuit connected to the storage circuits of the number of n in one pixel through switching means; and
an analog signal output from the D/A converter circuit is input to a gate electrode of the second TFT in the pixel connected to the D/A converter circuit through the switching means;
so that a predetermined current flows into the light-emitting element through the second TFT in the pixel.

14. A method of driving a light-emitting device according to claim 13, wherein the digital signals of n bits are once stored in the storage circuits of the number of n, and, then, the digital signals of n bits are input to the D/A converter circuit from the storage circuits of the number of n in the pixel, and the analog signal output from the D/A converter circuit is input to the gate terminal of the second TFT, which are repeated for a predetermined period of time.

15. A method of driving the light-emitting device according to claim 13, wherein the digital signals of n bits are once stored in the storage circuits of the number of n, and, then, the digital signals of n bits are input to the D/A converter circuit from the storage circuits of the number of n in the pixel, and the analog signal output from the D/A converter circuit is input to the gate terminal of the second TFT, which are repeated for a predetermined period of time, while halting the operation of the gate signal line drive circuit.

16. A method of driving the light-emitting device according to claim 13, wherein the digital signals of n bits are once stored in the storage circuits of the number of n, and, then, the digital signals of n bits are input to the D/A converter circuit from the storage circuits of the number of n in the pixel, and the analog signal output from the D/A converter circuit is input to the gate terminal of the second TFT, which are repeated for a predetermined period of time, while halting the operations of the source signal line drive circuit and of the gate signal line drive circuit.
